(19) United States
(12) Patent Application Publication
(10) Pub. No.: US 2006/0116913 A1
(43) Pub. Date: Jun. 1, 2006

(54) System, method, and computer program product for processing a claim

(75) Inventors: Kevin C. Hansan, Pound Ridge, NY (US); Zubin R. Wadia, White Plains, NY (US)

Correspondence Address: SQUIRE, SANDERS & DEMPSEY L.L.P, 600 HANSEN WAY, PALO ALTO, CA, 94304-1043, US

(73) Assignee: Lodi Systems, LLC, White Plains, NY (US)

(21) Appl. No.: 11/289,941

(22) Filed: Nov. 29, 2005

Related U.S. Application Data
(60) Provisional application No. 60/632,168, filed on Nov. 30, 2004.

(51) Int. Cl. G06Q 40/00

(52) U.S. Cl. 705/4

(57) ABSTRACT

A system, method, and computer program product for processing a claim are described. The system may include at least one intake site, a plurality of reviewers, one or more service providers, a bill payer and a claim process engine that may all be coupled to a network. In accordance with one embodiment, information about a claim brought by a claimant may be received from an intake site. A record for the claim may be created in a database that includes the information about the claim received from the intake site. Information from the record may be presented to one or more of the reviewers for determining whether to approve the claim. Information relating to an action taken by each reviewer regarding the claim may be received and the record in the database may be updated to include the information relating to the action. The intake site and/or the reviewer(s) may be provided with status information about a current status of the claim. The status information may be updated at least until the claim has been approved by the reviewer(s).

### CROSS REFERENCE TO RELATED APPLICATIONS

This application claims the benefit of U.S. Provisional Application No. 60/632,168 filed Nov. 30, 2004 and which is hereby incorporated by reference herein in its entirety.

### TECHNICAL FIELD

Embodiments of the present invention relate generally to record management and more particularly to medical and insurance record management and processing.

### BACKGROUND

Technological barriers and process opacity have led to “information islands” being formed in the Line of Duty Injury business process within self-insured organizations. Disparate systems and data sources in various departments (internal and/or external to the organization) serve only parts of this complex and pivotal business process leading to higher staff overheads, duplicate processing of claims and increased costs per processed claim.

Systems integrators and technology vendors have typically taken a traditional approach to resolving the problem of data islands through customized systems with standard web or client-server architectures that assert to offer clients the promise of data unification and process streamlining. This approaches usually fail due to the inherent complexities of the process, the length of time a transaction remains open in this business process, and the lack of interoperability between key “modules” designed by the system integrator.

### SUMMARY

A system, method, and computer program product for processing a claim are described. The system may include at least one intake site, a plurality of reviewers, one or more service providers, a bill payer and a claim process engine that may all be coupled to a network. In accordance with one embodiment, information about a claim brought by a claimant may be received from an intake site. A record for the claim may be created in a database that includes the information about the claim received from the intake site. Information from the record may be presented to one or more of the reviewers for determining whether to approve the claim. Information relating to an action taken by each reviewer regarding the claim may be received and the record in the database may be updated to include the information relating to the action. The intake site and/or the reviewer(s) may be provided with status information about a current status of the claim. The status information may be updated at least until the claim has been approved by the reviewer(s).

In one embodiment, the action taken by a reviewer may comprise recommending that a second reviewer review at least a portion of the information of the record. In another embodiment, the action may comprise sending the claim to a hold queue. After a predetermined amount of time after performance of the action, information from the record may be re-presented to the reviewer and the reviewer may be required to perform a subsequent action for determining whether to approve the claim. In another embodiment, information about previously taken actions relating to the claim may be presented to the intake site, service provider, bill payer and/or the reviewers. The information about previously taken actions may be presented as an audit trail in a graphical user interface.

In a further embodiment, the information received from the intake site, the reviewers, service provider, and bill payer may be received via a network. The intake site, the reviewers, service provider, and bill payer may be presented with graphical user interfaces for inputting information relating to the claim.

In one embodiment, an approval form may be generated after receipt of the approval from the reviewer. In another embodiment, a service provider may be provided access to information from the record associated with the claim for obtaining of an assessment of the claim from the service provider to identify a service for resolving the claim; receiving information relating to the assessment from the service provider; and updating the record in the database to include the information relating to the assessment. Information from the record may be presented to the reviewer(s) for determining whether to authorize the one or more services identified in the assessment within a predefined amount of time. An authorization may be received from the reviewer for performing the service(s) and a notification may be sent to the service provider indicating approval by the reviewer for performing the service(s). Information may also be received that indicates the performance of at least one of the approved services from the service provider after the service provider has performed the service. The record in the database may then be updated to include the information indicating the performance of the approved service(s). A notification may also be transmitted to the intake site, the reviewer(s) and/or the service provider that indicates the performance of the approved service(s).

In one embodiment, a bill payer may be presented with a graphical representation of a bill received for a service performed on the claimant. The graphical representation of the bill comprises a captured digital image obtained, for example, by scanning a paper copy of the bill using an image scanning device. Input for generating a payment for the bill may subsequently be received from the bill payer. The input may be obtained from the graphical representation of the bill and/or the information from the record. The record is the database may then be updated to include the input for generating the payment for the bill. Information from the record may be to one or more reviewers for determining whether to authorize the payment of the bill. In such an embodiment, the action performed by the reviewer may relate to the payment of the bill. When authorization for payment of the bill is received from the reviewer(s), the intake site, the service provider(s), the bill payer and/or the reviewer(s) may be provided with a notification that indicates the authorization for payment of the bill.

### BRIEF DESCRIPTION OF THE DRAWINGS

FIG. 1 is a schematic block diagram of an exemplary claim processing system architecture for implementing various embodiments of the present invention;

FIG. 2 is a schematic diagram of an exemplary main window of a graphical user interface used in a business process system in accordance with an exemplary embodiment;

FIG. 3 is a flowchart of a process for authorizing a claim in accordance with an embodiment of the claim processing system;

FIG. 4 is a schematic diagram of a Line of Duty process flow in accordance with an exemplary embodiment;

FIG. 5 is a schematic diagram of an exemplary Line of Duty Injury Control Log that may be displayed in graphical user interface to a Sick Desk clerk during a Line of Duty process;

FIG. 6 is a schematic diagram of an illustrative graphical user interface displaying an exemplary To Do list for a Line of Duty Desk clerk/user in accordance with an embodiment;

FIG. 7 is a schematic diagram of an exemplary Line of Duty Injury Report that may be displayed in a graphical user interface of the system in accordance with an illustrative embodiment;

FIG. 8 is a flowchart of a process for authorizing a service arising from a claim in accordance with an embodiment of the claim processing system;

FIG. 9 is a schematic diagram of an electronic Authorization Procedure process flow from an initial request to a final approval in accordance with an exemplary embodiment;

FIG. 10 is a schematic diagram of an illustrative version of the graphical user interface that may be presented to a clinic's personnel after logging in to the system in accordance with an exemplary embodiment;

FIG. 11 is a schematic diagram of an illustrative Officer Look Up form in an exemplary embodiment of an Authorization procedure;

FIG. 12 is a schematic diagram of an illustrative search result summary that may be displayed to a user via the graphical user interface in response to a search initiated by the user;

FIG. 13 is schematic diagram of an illustrative Authorization Request form that may be displayed via a graphical user interface in accordance with an exemplary embodiment;

FIG. 14 is a schematic diagram of an illustrative Authorization View displayed via a graphical user interface upon selection of an Authorization View tab in accordance with an exemplary embodiment;

FIG. 15 is a schematic diagram of an illustrative Notes display that may be displayed via a graphical user interface upon selection of an Notes tab in accordance with an exemplary embodiment;

FIG. 16 is a schematic diagram of an illustrative Audit Trail display that may be displayed via a graphical user interface upon selection of an Audit Trail tab in accordance with an exemplary embodiment;

FIG. 17 is a schematic diagram of an illustrative Authorization View that may be presented after selection of a link in a To Do List associated with an approved authorization in accordance with an exemplary embodiment;

FIG. 18 is a schematic diagram of an illustrative printable version of an Authorization form that may be displayed in response to selection of the Print and Archive action button of the Authorization View in accordance with an exemplary embodiment;

FIG. 19 is a flowchart of a process for authorizing payment of a treatment in accordance with an embodiment of a claim processing system;

FIG. 20 is a schematic process flow diagram of an illustrative bill payment procedure in accordance with an exemplary embodiment;

FIG. 21 is a schematic diagram of an illustrative version of a main window of a graphical user interface for use in a Bill Payment procedure in accordance with an exemplary embodiment;

FIG. 22 is a schematic diagram of an illustrative a New Bill lookup window of a graphical user interface for use in a Bill Payment procedure in accordance with an exemplary embodiment;

FIG. 23 is a schematic diagram of an illustrative Bill Payment Screen in accordance with an exemplary embodiment;

FIG. 24 is a schematic diagram of an illustrative embodiment of a Bill Payment screen displaying a Provider Lookup form in response to selection of the “Provider and Bill Information” tab in accordance with an exemplary embodiment;

FIG. 25 is a schematic diagram of an read only version of a Bill Details area in accordance with an exemplary embodiment;

FIG. 26 is a schematic diagram of an illustrative Procedure Codes form that may be presented to a Bill Payer in the Bill Payment Screen after selection of the Procedure Codes tab in accordance with an exemplary embodiment;

FIG. 27 is a schematic diagram of an illustrative Notes form of a Bill Payment Summary form presented by the system to a Bill Payer via a graphical user interface after selection of a Notes tab in the Bill Payment Summary form in accordance with an exemplary embodiment;

FIG. 28 is a schematic diagram of an illustrative Audit Trail form presented by the system to a Bill Payer via a graphical user interface after selection of an Audit Trail tab in the Bill Payment Summary form in accordance with an exemplary embodiment;

FIG. 29 is a schematic diagram of an illustrative graphical user interface for a Document Repository presenting Search and Results views in accordance with an exemplary embodiment;

FIG. 30 is a schematic diagram of an illustrative graphical user interface for a Document Repository presenting Profile, Document Selector, and Image views in accordance with an exemplary embodiment;

FIG. 31 is a schematic diagram of an illustrative network system for implementing an embodiment of the present invention; and

FIG. 32 is a schematic diagram of a representative hardware environment for implementing an embodiment of the present invention.

### DETAILED DESCRIPTION

Embodiments of the adaptive technology framework may help to dissipate information boundaries between Line of Duty specific process areas by casting a unique “process net” across the entire operation. A unified platform helps to improve inter-operability between key process areas, allowing real-time data exchange and providing instant insight into potential bottlenecks and business statistics. In Line of Duty Injury processing this translates to faster processing of claims, more accurate reimbursement to providers for treatment, better audit trails of actions performed in the process and decreased costs per processed claim.

An embodiment of a process net may comprise processes for injury reporting, treatment authorization, claims processing and litigation processing. In the injury reporting process Line of Duty personnel may report injuries to their head office. In the treatment authorization process, Line of Duty personnel may be evaluated and authorized to receive treatment. In the claims processing process, provider reimbursement for treatment administered to Line of Duty personnel may be provided based on standardized fee schedules. In the litigation processing process, dispute resolution of claims may be accomplished via litigation and/or arbitration.

By taking a process enabled approach to the problem, an adaptive framework may help circumvent the traditional pitfalls associated with modular web or client-server technologies. A digital process with established roles, rules and conflict resolution as technology pillars allow us to weave all the major process areas together into a seamless progression of content until the transaction (an item/claim) reaches end of life. Once it reaches end-of-life, the item/claim is now archived as a business record and its history available for business intelligence and reporting needs.

In order for a process to be successful and replicable it should also be portable. Thus, embodiments of the Line of Duty process may be architected entirely in the Business Process Execution Language (BPEL), an industry standard platform for process articulation that is supported by Oracle, IBM, Microsoft and Sun. A BPEL-compliant process may be redeployed successfully across multiple platforms/frameworks/engines without having to redefine it.

A BPEL-compliant process template helps to address the needs of the Line of Duty injury processing industry and offers participants an extremely flexible architecture that “moulds” to their current structure. Organizations are generally structured in three ways:

1. Completely internal—where all process areas and indigenously handled by the entity but have different systems handling each segment.

2. Completely external—where all process areas are bid out to “service experts” who perform independently of one another. In this structure, there is generally negligible validation and verification between different entities leading to the highest cost overheads.

3. Hybrid—Where certain sensitive areas of the process are performed internally but other more common place aspects are handled externally. An inherent disadvantage of this approach is the overhead involved in keeping both external and internal operations synchronized in relation to data exchange and business rule negotiation.

Research with clients and prospective clients has shown that the completely internal approach built upon a BPEL-compliant process template helps to offer participants a highest degree of flexibility, lower overall cost and help maximize efficiency within an organizations' Line of Duty injury process. Embodiments of the template can also be adapted effectively to work in a hybrid environment where outsourced process areas can be perceived as “information agents” that feed back the relevant data it needs to progress an item/claim through the master process.

A BPEL-compliant process template may be governed by the process net, an all-purpose template that weaves together all process areas required by self-insured organizations for their Line of Duty business. This master process coordinates and oversees the sub-processes that address more granular business rules, user/role interactions and conditional processing such as injury reporting process, treatment authorization, fee schedule maintenance, claims processing, litigation processing, record acceptance, management and destruction, and business intelligence and statistics.

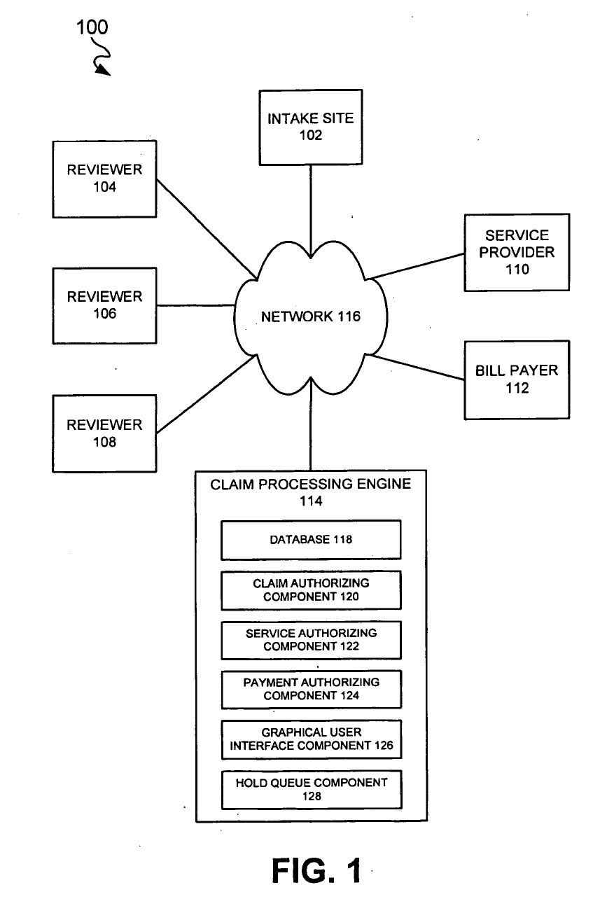

FIG. 1 is a schematic block diagram of an exemplary claim processing system architecture 100 for implementing various embodiments of the present invention. The system 100 may include at least one intake site 102, a plurality of reviewers 104, 106, 108, one or more service providers 110, a bill payer 112 and a claim processing engine 114 coupled together by a network 116. The claim processing engine 114 may include a database 118 for storing information as well as components for authorizing a claim (claim authorizing component 120), for authorizing services arising from a claim (service authorizing component 122) and for authorizing payment (payment authorizing component 124). The claim processing engine may further include a graphical user interface component 126 for generating graphical user interface implemented in embodiments of the system 100 and a hold queue component 128 for hold queuing features implemented in embodiments of the system 100.

Business process management software automates paper shuffle effectively by electronically routing information to appropriate persons while remaining flexible enough to accommodate rule exceptions. A workflow solution can automatically remind you of required tasks, and notify supervisors of action and inaction. Business process management solutions regard you as responsible knowledge workers whose time is better spent making decisions than making copies. The business process management term for a complete business process is a procedure. A procedure comprises of one or more maps, any number of forms, a role list and a flag list.

A folder is an object that progresses through the procedure. Each time a business process is initiated, the system creates a folder containing one or more electronic pages of information. Users can add or edit the information on the folder pages by clicking on actions. A folder can also contain documents, such as scanned bills. There is only ever one copy of a folder passing through the procedure at any one time. There is no duplication and everyone involved with the procedure is working from the same source of information.

Web Client

When a user wants to work on folders that are being routed through a procedure, a first step may be to login to the system. This may be accomplished by opening a web browser and entering a URL to a business process management system site. Upon entering the site, a user may to connect to one of the services provided by the site. A service authentication login window may be provided for receiving a user name and password for controlling access to the service.

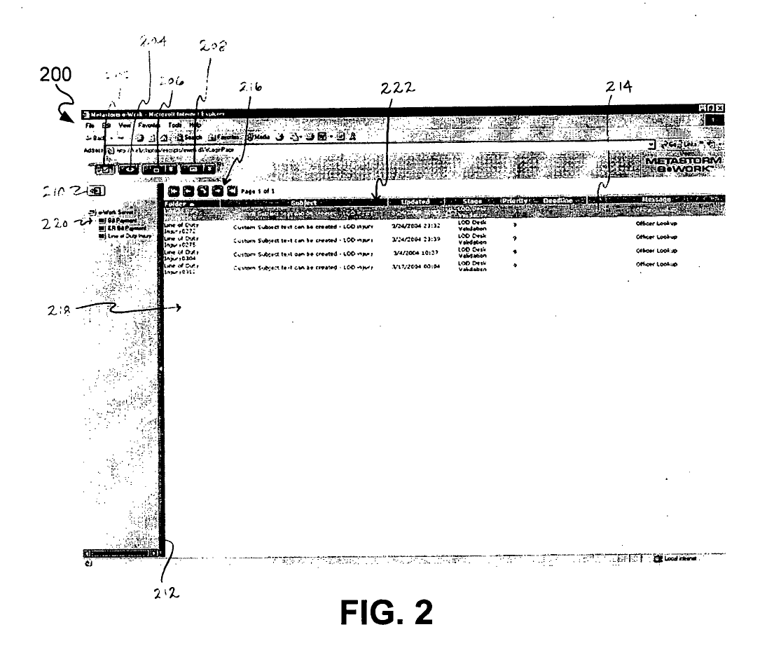

Once logged in, the system may present a user with a main window of the business process management system. FIG. 2 is a schematic diagram of an exemplary main window of a graphical user interface 200 used in a business process system in accordance with an exemplary embodiment. The main window may include the following elements:

a) List Selection Buttons may be used to display four lists: To Do 202, Watch 204, Blank Forms 206 and Admin Forms 208. Clicking a List Selection for the currently displayed list refreshes data displayed in the list.

b) Logout Button 210 may be used to log out of all of the services that a user is connected to.

c) Splitter Bar 212 may allow a user to drag the divider line and horizontally resize the List Filter and List.

d) List Filter 214 may allow a user to filter the items that appear on the currently selected list.

e) Paging Buttons 216 may allow a user to navigate the pages of the current list.

f) List Viewing Area 218 may display a variety of data. The data displayed in this area may dependent upon which list is selected in the List Selection buttons. To view a particular list, a user may click on the appropriate button 202, 204, 206, 208 from the List Selection buttons bar. The folders and forms that are displayed in the selected list are based on the service and level currently selected in the List Filter as well as the user's role and responsibilities within a given process.

g) The To Do List button 202 allows a user to display summary information about the folders on which the user can perform an action. The Watch List button 204 allows a user to display summary information about the folders the user can monitor. The user may also be authorized to act on folder in this list. The system/claim processing engine determines the folders displayed on a user's To Do List and Watch List when the user logs in.

List Filter 214

Some users will have responsibilities in multiple processes and their To Do and Watch lists may quickly fill up. Filtering the lists allows a user to locate a specific form or folder from a group. The lists of forms and folders can be filtered using the List Filter 214.

To filter a list to a specific stage or process, a user may click its title in the opened tree structure 220 in the left panel. The list may then refresh with only those folders currently at the selected stage or process.

In some process, a user may have access to many forms and may be required to monitor many folders. In these situations, folders and forms available for viewing may extend beyond the currently visible viewing page of the list. To navigate to different pages of the list, a series of Paging Buttons 216 may be provided at the top of the list. As shown in FIG. 2, the Paging Buttons 216 may include (from left to right) a First Page button, a Previous Page button, a Go To Page button, a Next Page button and a Last Page button.

Selection of the First Page button may display the first page of the list. Selection of the Previous Page button may display the page previous to a currently displayed page. The Go To Page button may be selected to display a sub-window into which a user may input/identify the specific numbered page to be displayed. Selection of the Next Page button may display the page immediately following the currently displayed page. Selection of the Last Page button may display the last page of the list.

Sorting Lists

Entries of a displayed list may be sorted by a user via a column header bar 222. As shown in FIG. 2, the column headers included in the column header bar 222 may include headers for the following fields: Folder, Subject, Updated, Stage, Priority, Deadline and Message fields/columns. To sort folders according to a particular column, a user may click on the displayed header of a given column displayed in the column header bar 222. When sorting, the Folder, Subject and Message fields may be ordered alphabetically while the Updated and Deadline fields may be ordered by date. For the Priority field, the list may be ordered by priority level with those entries having the same priority being ranked secondarily by the Updated (date) field. When an up arrow is displayed, the list may be presented in ascending order based on the selected column. Conversely, when a down arrow is displayed, the list may be presented in descending order based on the column selected.

To Do List

As previously described, a To Do List may be displayed by selection of the To Do button 202. Each user's To Do List contains the folders on which the user may be required to perform an action. The claim processing engine may automatically update this list whenever a folder reaches a stage for which the user is defined on the To Do List.

When the To Do List is displayed, the following columns may be displayed for each folder in the list:

a) Folder—folder name.

b) Subject—subject for the folder.

c) Updated—the time of the folder's latest alert.

d) Stage—name of the stage the folder is currently at.

e) Priority—priority of the folder (e.g., priority 1 Being the highest and priority 9 is the lowest).

f) Deadline—deadline of the folder.

g) Message—message displayed by the last action.

To open a folder in the displayed list, a user may click on the folder's entry. The folder will then be opened and displayed with the folder pages and actions appropriate for the current stage.

Watch List

A Watch List may be displayed by selection of the Watch List button 204. The Watch List is very similar to the To Do List although users do not normally have to perform an action on folders displayed in their Watch List—the folders are displayed so that users can monitor the status of the folder as it progresses through the procedure.

Blank Forms

Blank forms are empty forms that users complete to create a folder and begin a procedure. When a user clicks on the Blank Forms button 206 the list selection, all of the blank forms for which the user has access may be displayed. The user may then click on the desired form entry to load the blank form. After the user has completed the data entry required for the form, the user may click on a Submit button (which may be presented in a bottom right corner of the graphical user interface 200). This action writes the data to the database, creates the folder, and routes it to the first stage of the associated process flow.

Administrative Forms

Administrative Forms are used for administration purposes and may not initiate any process when submitted. A user's role will determine which forms appear on his Administrative Forms list upon selection of the Administrative Forms button 208.

The following section(s) describe the procedure(s) and form(s) used in various process flows of the system.

Claim Authorization/Line of Duty Procedure

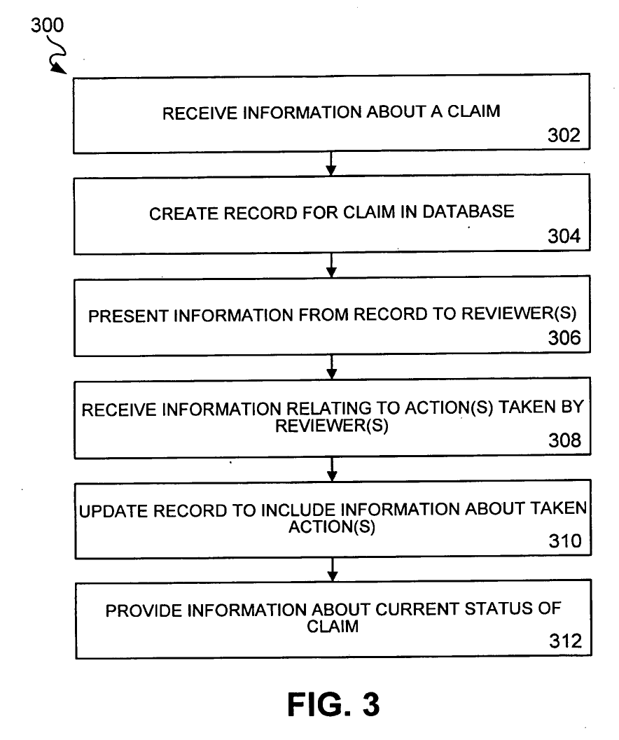

FIG. 3 is a flowchart of a process 300 for authorizing a claim in accordance with an embodiment of the claim processing system. In operation 302, information about a claim brought by a claimant may be received. In an illustrative embodiment, the claim may relate to an injury or illness. For example, the claim may relate to an injury/illness that occurred during a course of the claimant's employment (i.e., while the claimant was working at his or her job). The information about the claim may be input into a graphical user interface that is presented at an intake site via a network. Similarly, the input information about the claim may be received from the intake site via the network.

In operation 304, a record for the claim may be created in a database. The record may include the information about the claim received from the intake site. In operation 306, information from the record may be presented to one or more reviewers that review the information from the record to determine whether to approve the claim. In one embodiment, information from the record may be presented to each reviewer via the network.

In response to presenting the information in operation 306, each reviewer may be required to perform an action (i.e., some kind of response) relating to the claim within a predefined amount of time. In operation 308, information relating to the action taken by each reviewer regarding the claim may be received from the respective reviewer. The reviewer may be presented with a graphical user interface for inputting information relating to the claim. The presentation of the graphical user interface and receipt of the information about the action may both occur via the network. One action that may be performed by the reviewer (and that may also be performed by the intake site as well as) may comprise sending the claim to a hold queue (also referred to as a hold action) to await performance of another action by (or further information from) the reviewer/intake site or another party in the system. In one embodiment, information from record may subsequently be re-presented to the reviewer after a predetermined amount of time from the taking of a hold action by the reviewer to require the reviewer to perform a subsequent action for determining whether to approve the claim. Another action that may be taken by the reviewer may comprise recommending that a second reviewer review at least a portion of the information of the record.

The record in the database may be updated to include the information relating to the action taken by the reviewer(s) (see operation 310). In one embodiment, information about previously taken actions relating to the claim may be presented to the intake site and/or the reviewer(s). This information may be presented, for example, as an audit trail in a graphical user interface.

In operation 312, the intake site and/or the reviewer(s) may be provided with status information about a current status of the claim. In one implementation, the provided status information may be updated at least until the claim has been approved by all of the required reviewers. After receipt of the approval from all of the reviewer(s), an approval form/document may be generated indicating the approval of the claim.

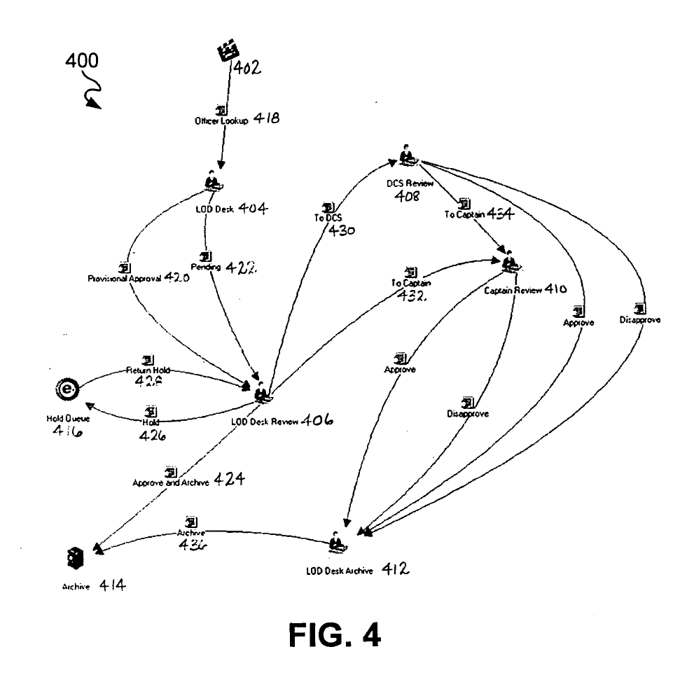

Further details of an claim authorization process will now be described with use of the following illustrative Line of Duty Procedure in accordance with an exemplary embodiment. In a Line of Duty Procedure, Sick Desk operators, Line of Duty Desk Clerk, Deputy Chief Surgeon, and Captain may interact with the system to log, validate, monitor and archive an electronic Line of Duty Injury Report (LODIR). FIG. 4 is a schematic diagram of a Line of Duty process flow 400 in accordance with an exemplary embodiment. The Line of Duty process diagram of FIG. 4 illustrates the process flow 400 of an electronic Line of Duty Injury report. The process 400 may be initiated when a Sick Desk operator (see element 402) logs a Line of Duty injury and submits it to a Line of Duty Desk 404. From this point, the Line of Duty Desk clerk 404 may have more than one way to handle an electronic LODIR. The LOD procedure may comprise a plurality of stages, actions, forms and roles.

Stages

As shown in FIG. 4, exemplary stages that may be included in a LOD process 400 may include:

a) Sick Desk Form Submission 402;

b) Line of Duty Desk (initial review) 404;

c) Line of Duty Desk Review (validation of LODIR) 406;

d) Deputy Chief Surgeon Review (situational) 408;

e) Captain Review (situational) 410;

f) Line of Duty Archive(s) 412, 414; and

g) Hold Queue 416.

Actions

The plurality of actions in the exemplary LOD process 400 may include:

a) Officer Lookup and Submission of Line of Duty Control Log 418;

b) Provisional Approval 420;

c) Pending 422;

d) Approve and Archive 424;

e) Send to Hold Queue 426;

f) Return from Hold Queue 428;

g) Send to Deputy Chief Surgeon 430;

h) Send to Captain 432, 434;

i) Send to Archive (after Captain approval) 436;

j) Add a Note;

k) View Audit Trail; and

l) View Notes.

Electronic Forms

An LOD process 400 may include the following electric forms:

a) Line of Duty Control Log (sick desk);

b) Line of Duty Injury Report; and

c) Note.

Roles

As shown in FIG. 4, the roles or parties involved in the LOD process 400 may include:

a) Sick Desk Operator (at element 402);

b) Line of Duty Desk Clerk 404;

d) Deputy Chief Surgeon 408; and

e) Captain 410.

The following sections describe further details of the operations of the LOD process 400 as they relate to the previously set forth four roles of this procedure 400 (i.e., (Sick Desk Operator 402, Line of Duty Desk Clerk 404, Deputy Chief Surgeon 406, and Captain 408).

Sick Desk 402

To initiate a LOD process 400 at a Sick Desk 402, a user at the Sick Desk 402 may log in to the system via a network. Once logged in, the user may click on the Blank Forms list selection button 206 and select Line of Duty Injury to start a new folder in the Line of Duty Injury process by opening a blank Line of Duty Injury Control Log form.

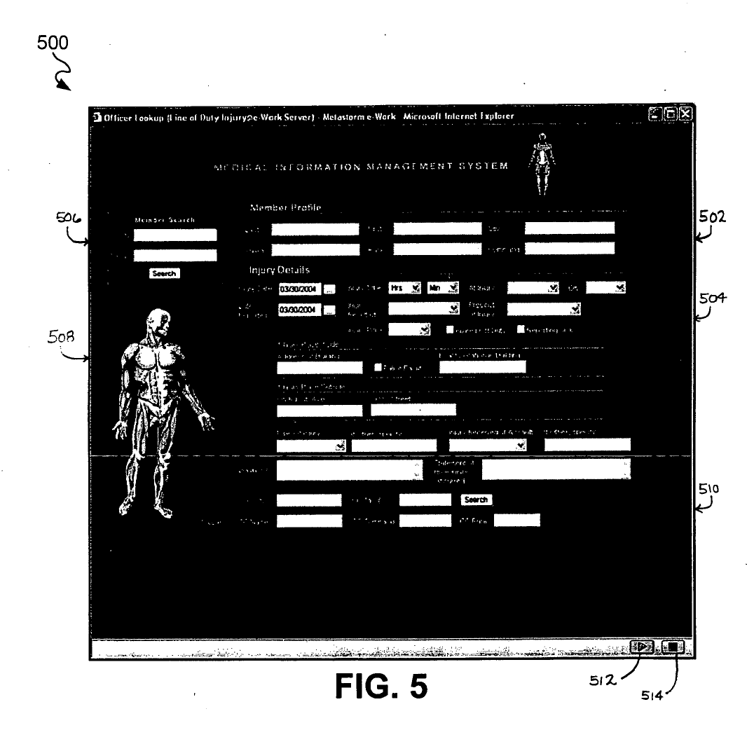

FIG. 5 is a schematic diagram of an exemplary Line of Duty Injury Control Log 500 that may be displayed in graphical user interface to a Sick Desk clerk 402 during a Line of Duty process 400. The form 500 may include two main sections to be filled: Member Profile 502 and Injury Details 504.

Completing the Line of Duty Control Log may be Accomplished Via the Following Steps:

Step 1: Member Lookup 506—To fill in the Member Profile section, enter the member's Social Security Number (SSN) or Tax ID in the Member Search box at the top left corner and click Search.

Step 2: Auto Complete Member Profile 502—Upon clicking Search, if the target member is in the system, the Member Profile fields will populate with available data; otherwise, the Line of Duty must be treated as before and input manually into the system (e.g., via the graphical user interface)

Step 3: Injury Details 504—Fill in the Injury Details section with as much detail as possible. The following table sets forth a variety of exemplary injury detail fields that may be provided in the Line of Duty Control Log along with illustrative formats and selections for each field.

| Field | Format | Selection (if applicable) |
|---|---|---|
| Injury Date | Date Selector | |
| Injury Time | Drop-down | 00-23 hours, 0-59 minutes |
| | menu | |
| At Injury | Drop-down | Alone or With MOS |
| | menu | |
| On | Drop-down | Foot, RMP, or Other |
| | menu | |
| Date Reported | Date Selector | |
| Injury Result of | Drop-down | Assault, Dept. Veh. Accident, |
| | menu | or Other |
| Precinct of Injury | Drop-down | All precincts |
| | menu | |
| Injury Place | Drop-down | Inside or Outside |
| | menu | |
| Injury Off Duty | Check | Yes/No |
| Reporting Sick | Check | Yes/No |
| Address of Building | Text | |
| Police Facility | Check | Yes/No |
| Exact Location | Text | |
| in Building | | |
| On Rd, St, Ave | Text | |
| Cross Street | Text | |
| Type of Injury | Drop-down | Abrasion, Burn, Foreign Body, |
| | menu | Fracture, Puncture Wound, |
| | | Sprain/Strain, Laceration, |
| | | Contusion, Hernia, Dislocation, |
| | | Concussion, or Other |
| If other, | Text | |
| specify type | | |
| Injury Received, | Drop-down | Gunshot, Bite, Kick, Cut/Stab, |
| if Assault | menu | Punch, Struck by Object, Assault |
| | | by Vehicle, or Other |
| If Other, specify | Text | |
| Diagnosis | Text | |
| Statement of How | Text | |
| Injury Occurred | | |

Step 4: Body Part Selection 508—A user may mouse over the human figure displayed in the Body Parts Selection portion 508 of the Log 500 and click the affected body parts. In one embodiment, selected body parts may appear in red. To de-select a body part, a user may click on the selection again. A user may click a Toggle selection in the Body Part Selection portion 508 to flip the human figure and select backside parts of the body.

Step 5: Commanding Officer 510—To fill in the Commanding Officer's information, enter the CO's Social Security Number (SSN) or Tax ID in the textbox and click a Search selection to populate the data.

Once a user has completed the form, the user may click a green Submit button 512 located in the lower right corner of the form 500. To cancel out of the form 500, a user may click a red Cancel button 514.

After submitting the completed form, the system may present a pop up window to the user via the graphical user interface that displays a LOD number issued to the LOD claim when the form has been successfully submitted.

Next, the completed Line of Duty Control Log 500 may be sent to a To Do list of a Line of Duty Desk Clerk 404.

Line of Duty Desk 404/406

The LOD Desk 406 is the hub for all LODIRs. The LOD Desk clerk 406 will receive new and existing folders in his/her To Do list regarding LODIRs at different stages of review. With assistance from the DCS 408, Captain 410 and Command, LODIRs are assessed and decisions are made in agreement or disagreement with the reports before they are permanently filed in the Members' medical folders.

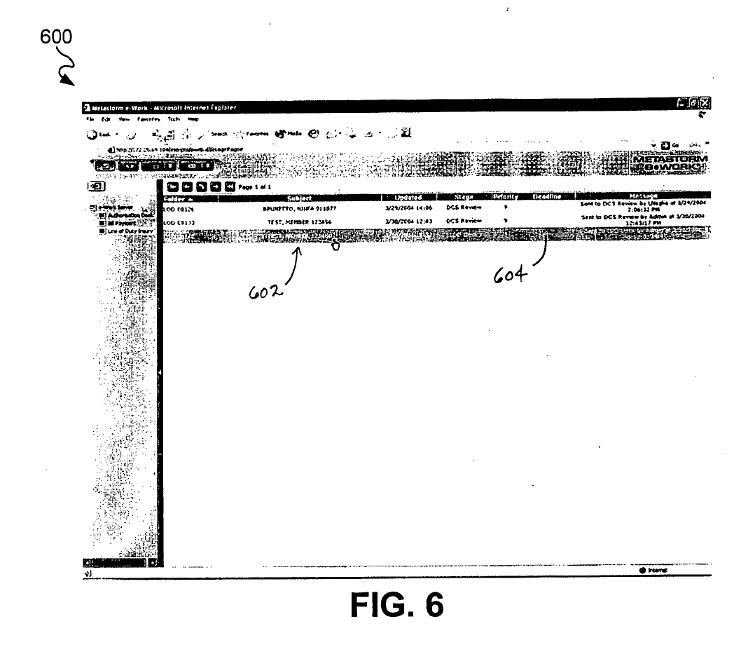

A user at the Line of Duty Desk 404 may log in to the system via a network. Once logged in, the user may click on the To Do list selection button 202 to display a To Do list for the Line of Duty Desk 404. FIG. 6 is a schematic diagram of an illustrative graphical user interface 600 displaying an exemplary To Do list 602 for a Line of Duty Desk clerk/user 404 in accordance with an embodiment. The To Do list 602 of the Line of Duty Desk clerk may hold more than one type of task. For each task, the graphical user interface may present an entry (e.g., selected entry 604) having a folder name, subject, date/time last updated, a stage name, a priority level, a deadline (if applicable), and an alert message. To open a task on the To Do list 602, a user may click on the selection (e.g., selected entry 604). Opening the task will present an electronic Line of Duty Injury Report with previously filled in data associated with the folder.

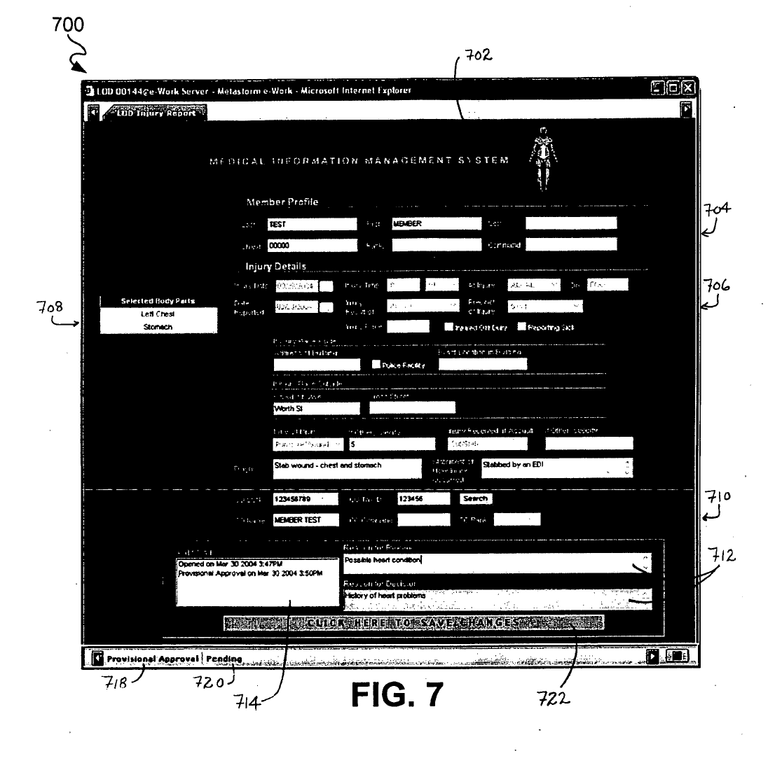

FIG. 7 is a schematic diagram of an exemplary Line of Duty Injury Report 700 that may be displayed in a graphical user interface of the system in accordance with an illustrative embodiment. As shown in the exemplary embodiment of FIG. 7, the form may be composed of nine areas. During the process, the Line of Duty clerk may be responsible for reviewing the areas of the form 700 for errors, inaccuracies, or other potential issues. The areas of the Line of Duty Injury Report 700 may include:

a) LOD Number 702—Unique identifier auto-generated by the Sick Desk log entry 500.

b) Member Profile 704—Injured Member's pedigree information pulled in from the system.

c) Injury Details 706—Information pertaining to the Member's injury and the circumstances surrounding it as reported by the Member's Commanding Officer and recorded by a Sick Desk operator 402.

d) Affected Body Parts 708—List of injured or affected body parts as recorded by Sick Desk 402.

e) Commanding Officer Details 710—Pedigree information of the CO who reported the Line of Duty injury.

f) Remarks 712—Reasons for further review/ruling as determined by Line of Duty desk clerk 404, Deputy Chief Surgeon 408, or Captain 410.

g) Audit Trail 714—A log of all the stages that the Line of Duty folder has passed through since it was opened (e.g., Captain Review).

h) Save Button 716—If any change is made to the form, a user may press the “Click here to Save Changes” button to save edits in the system.

Once a user has given the electronic form an initial review, the user may then decide how to mark this folder. The user may click one of the following selections:

a) Grant the folder Provisional Approval by selecting a Provisional Approval button 718. This will allow an authorization to be given for treatment of specified body parts.

b) Mark the folder as Pending by selecting a Pending button 720. A folder that is pending will not be granted an authorization until it has been approved.

c) Cancel (via Cancel button 514) out of the form and process this task at a later time.

When a Line of Duty Desk user 404 chooses Provisional Approval or Pending, the task will file itself back in the user's To Do list to be addressed when the LODIR comes in, and the message field will read provisional approval or pending. When the LODIR arrives from Command and the Line of Duty Desk 404 is ready to process the folder, the task may be reopened from the Line of Duty Desk's To Do list for review by the Line of Duty Desk (i.e., Line of Duty Desk Review 406).

In one embodiment, to more easily locate a task on a To Do list, a user may be permitted to sort the Folder column (LOD Number) by clicking the column header. The subject indicates the Member's last name, first name and tax ID.

The re-opened electronic form may then be compared against the original LODIR. At this stage, Line of Duty Desk 406 may have the following options:

a) Approve and Archive 424—to approve and permanently file the record.

b) To DCS 430—If this record needs to be sent to the Deputy Chief Surgeon 408 for a second opinion, the following steps may be performed:

i) Enter reasons in the Reason for Review textbox.

ii) Click the “Click Here to Save Changes” button 722.

ii) Click a To DCS selection to move the task off the To Do list and onto the Deputy Chief Surgeon's 408 To Do list.

iv) When the DCS 408 submits a decision, this task may be routed to the Captain 410 (see action 434) before it is returned to the LOD Desk with its stage marked LOD Desk Archive 412. The Audit Trail and remarks area of the LOD form may display the status.

c) To Captain 432—If the record needs to be sent to the Captain 410 for a ruling, the following steps may be performed:

i) Enter comments in the “Reason for Review” textbox.

ii) Click the “Click Here to Save Changes” button.

iii) Click a To Captain selection to move the task off the To Do list onto the Captain's list.

iv) When the Captain 410 submits a decision (e.g., Approve or Disapprove), this task will reappear in the LOD Desk's To Do list with its stage marked LOD Desk Archive, and the Audit Trail and remarks area of the LOD form will display the status.

d) Hold 426—Send to a hold queue 416 to be processed later. Hold items will automatically return to the LOD Desk's 406 To Do list in a pre-set number of days. Alternatively, the LOD Desk 406 may manually retrieve an item from the Hold queue 416.

Approved LODIRs may go into the archive 414. LODIRs that are sent to the hold queue 416 or to the DCS/Captain 408/410 will be routed as specified above. When the task returns to the LOD Desk's 406 To Do list, the LOD Desk may be required to process the task further as follows:

a) Hold tasks—The LOD Desk may automatically receive or manually retrieve folders from the Hold Queue for which one of the options previously described may then be performed.

b) Archive tasks—Folders returned from the DCS/Captain will need to be archived. Verify a decision has been marked in the Audit Trail and remarks section of the LODIR. Click on an Archive selection to permanently file the report.

Deputy Chief Surgeon 408

The following section describes how a Deputy Chief Surgeon 408 (DCS) may utilize the system in a Line of Duty Procedure 400. The Deputy Chief Surgeon 408 may log in to the system via a network. Once logged in, the Deputy Chief Surgeon 408 may click on the To Do list selection button 202 to display a To Do list for the Deputy Chief Surgeon 408. For each task in the Deputy Chief Surgeon's To Do list, the Deputy Chief Surgeon 408 will see the folder name (LOD number), subject (member name and tax ID), date/time last updated, stage name, priority level, deadline and an alert message in the list. To open a task, the Deputy Chief Surgeon 408 may click on a selection in the To Do list. The corresponding electronic Line of Duty Injury Report 700 will then open pre-populated with data.

In addition to Line of Duty, the DCS role may apply to the Authorization and Bill Payment procedures, as well. As a result, the DCS' To Do list may contain tasks from all of these procedures. To filter the To Do list by tasks, the Deputy Chief Surgeon 408 may click on the procedure name in the left panel 220.

The Deputy Chief Surgeon 408 may then review the form 700 for accuracy. As previously described, the LODIR 700 may have sections: member profile 704, injury details 706, audit trail 714 and remarks 712. Comments or concerns from the originator (i.e., LOD Desk clerk 404) may also appear in the remarks area 712. Using the details from the LODIR and the member's documents, the Deputy Chief Surgeon 408 may then make a determination on the Line of Duty injury and enter comments in the Reason for Decision field of the remarks area 712. The Deputy Chief Surgeon 408 may then select the “Click Here to Save Changes” button 722 to save the edits/additions to the folder with the system. The Deputy Chief Surgeon 408 may then select a final action (i.e., Approve or Disapprove) and send the folder to the Captain's To Do list (see Action 434).

Captain 410

In a Line of Duty procedure, a Captain 410 may log into the system utilizing a similar procedure as that previous described for the LOD Desk 406 and Deputy Chief Surgeon 408. Once the Captain 410 is logged in to the system, the Captain 410 may click on the To Do list selection button 202 of the graphical user interface 200 to view the Captain's To Do list. Each task in the Captain 410 To Do list will be presented as an entry having a folder name (LOD number), subject (member name and tax ID), date/time last updated, stage name, priority level, deadline and an alert message. The Captain may receive LODIRs from the LOD Desk directly or from the Deputy Chief Surgeon. The alert message field of the To Do list indicates where the task has originated from.

The Captain 410 may open a task by click on the selection and view the electronic Line of Duty Injury Report 700 with pre-populated with data provided from the database. The Captain 410 may then review the form 700. As previously discussed, the LODIR 700 may include several sections: member profile 704, injury details 706, audit trail 714 and remarks 712. Comments or concerns from the originator (e.g., LOD Desk clerk 404 or DCS 408) may appear in the remarks area 0512.

Using information supplied by the LODIR and the member's digital records stored in the MIMS Document Repository, the Captain 410 may make a determination on the Line of Duty injury and enter comments in the “Reason for Decision” field of the remarks area 712. The Captain 410 may then press the “Click Here to Save Changes” button 722 to save his or her edits/additions. The Captain 410 may then select a final action (Approve or Disapprove) and send the folder to the LOD Desk Archive stage 412 to be permanently filed in the Archive 414.

Watch List

A Watch List may be presented to the Captain 410. The Watch List is very similar to the To Do list. Folders may be displayed in the Watch List so that the Captain 41 can monitor the status of the folder as it progresses through the procedure 400. The Captain 410 may access the Watch List by clicking on the Watch List selection button 204 of the graphical user interface.

Treatment Authorization

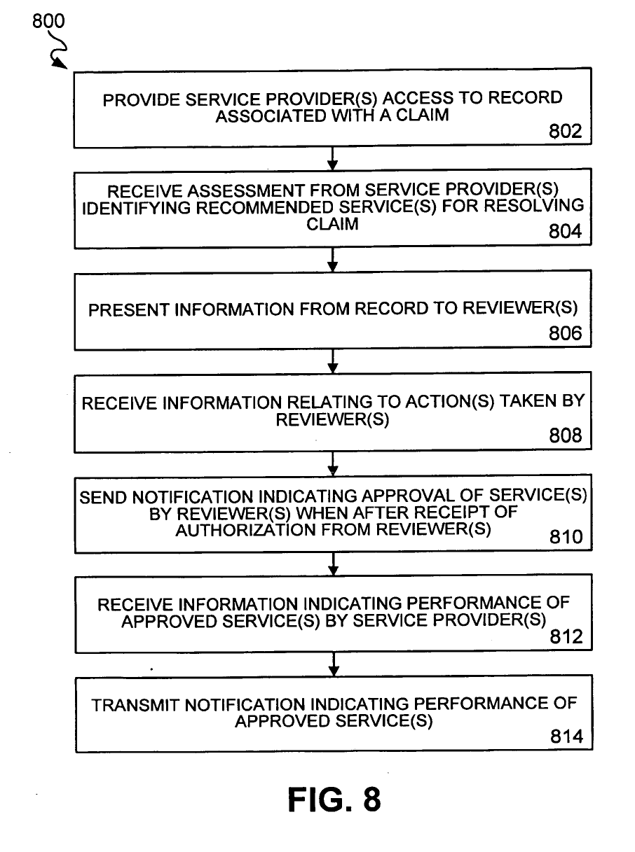

FIG. 8 is a flowchart of a process 800 for authorizing a service arising from a claim in accordance with an embodiment of the claim processing system. In operation 802, a service provider may be provided access to information from a record associated with a claim brought by a claimant. The information from the record may include an authorization for the claimant to obtain an assessment from the service provider for resolving the claim. The access may be provided to the service provider utilizing a graphical user interface presented to the service provider via a network. The record may be stored in a database than may be accessed via the network.

The service provider may then assess the claim to identify service(s) for resolving the claim. The service provider may input an assessment of the claim into a graphical user interface presented to the service provider via the network. The assessment may be received from the service provider via the network (see operation 804). The assessment may include a recommendation for performing one or more services for resolving the claim. In one implementation, a service may comprise a treatment and/or a diagnosis of an injury or an illness. The record in the database may be updated to include the information from the assessment made by the service provider.

In operation 806, information from the record may then be presented to one or more reviewers for reviewing the information from the record in order to determine whether to approve or reject the service(s) recommendation submitted by the service provider. The information from the record may be presented to each reviewer via the network.

In response to operation 806, each reviewer may be required to perform an action (i.e., some kind of response) that relates to the assessment within a predefined amount of time. Information relating to the action taken by each reviewer regarding the assessment may be received (e.g., via the network) in operation 808. The record in the database may be updated to include the information relating to the action taken by the reviewer(s). One action that may be performed may comprise sending the assessment to a hold queue (also referred to as a hold action) to await performance of another action by (or further information from) the reviewer or another party in the system. The assessment may subsequently be re-presented to the reviewer after a predetermined amount of time from the taking of a hold action by the reviewer to require the reviewer to perform a subsequent action. Another action that may be taken by the reviewer may comprise recommending that a second reviewer review at least a portion of the information of the record and to assist in the determination of whether to approve or reject the proposed recommended services in the assessment.

When an authorization from the reviewer for performing the one or more services is received, a notification may be sent to the service provider (and/or an intake site and/or a reviewer) that indicates the approval of the service by the reviewer (see operation 810). The notification may be sent to the service provider via the network and presented to the service provider via the graphical user interface.

The service provider and/or the reviewer(s) may also be provided with status information about a current status of the claim. The provided status information may be updated at least until the recommended services have been approved by each of the reviewers. After a service provider has performed at least one of the approved services on the claimant, information indicating the performance of the approved service(s) may be received from the service provider in operation 812. The service provider may input this information via a graphical user interface presented to the service provider. The record associated with the claim may then be updated to include the information indicating the performance of the approved service(s) and a notification may be transmitted to the service provider and/or the reviewer(s) (and/or an intake site) that indicates the performance of the approved service(s) (see operation 814). Both the presentation of the graphical user interface, receipt of the information indicating the performance of the approved service(s), and the notification that indicates the performance of the approved service(s) may occur via the network.

Further details of a treatment authorization procedure will now be described with use of the following illustrative Authorization Procedure in accordance with an exemplary embodiment.

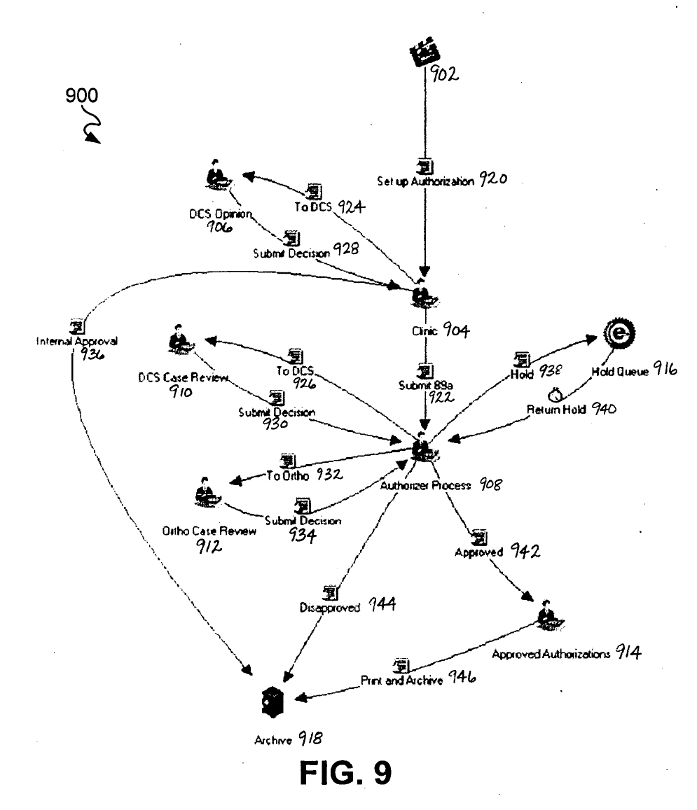

FIG. 9 is a schematic diagram of an electronic Authorization Procedure process flow 900 from an initial request to a final approval in accordance with an exemplary embodiment. In this process 900, clinic personnel may interact with the system to process a request for authorization for services. The Authorization procedure 900 may comprise a plurality of stages, actions, forms and roles.

Stages

As shown in FIG. 9, exemplary stages that may be included in an Authorization procedure 900 may include:

a) Authorization Request Form Submission 902;

b) Clinic (validation) 904;

c) Deputy Chief Surgeon Opinion (situational) 906;

d) Authorizer Process 908;

e) Deputy Chief Surgeon Case Review (situational) 910;

f) Orthopedic Surgeon Case Review (situational) 912;

g) Approved Authorizations 914;

h) Hold Queue 916; and

i) Archive 918.

Actions

The plurality of actions that may be included in an Authorization procedure 900 may include:

a) Set up Authorization (process kick-off) 920;

b) Submit 89a (to Authorization Process) 922;

c) Send to DCS (from Clinic) 924;

d) Send to DCS (from Authorization Desk) 926;

e) DCS Submit Decision to Clinic 928;

f) DCS Submit Decision to Authorization Desk 930;

g) Send to Ortho Surgeon 932;

h) Ortho Submit Decision to Authorization Desk 934;

i) Internal (Clinic) Approval 936;

j) Send to Hold Queue 938;

k) Return from Hold Queue 940;

l) Approve Authorization/Send to Clinic/Archive 942;

m) Disapprove Authorization/Send to Archive 944;

n) Print and Archive 946;

o) Add Notes;

p) View Notes; and

q) View Audit Trail.

Electronic Forms

An Authorization procedure 900 may include the following electric forms:

a) Officer Lookup;

b) Authorization Request (89a);

c) Authorization (89b); and

d) Note.

Roles

As shown in FIG. 9, the roles or parties involved in and Authorization procedure 900 may include:

a) District Surgeon (i.e., doctor)/Clinic (at element 904);

b) Deputy Chief Surgeon (at elements 906 and 910);

c) Orthopedic Surgeon (at element 912); and

d) Authorization Desk Clerk (at element 914).

The following sections describe further details of the operations of the exemplary Authorization procedure 900 as they relate to various roles of the procedure 900.

Clinic/Doctor Role in an Authorization Procedure

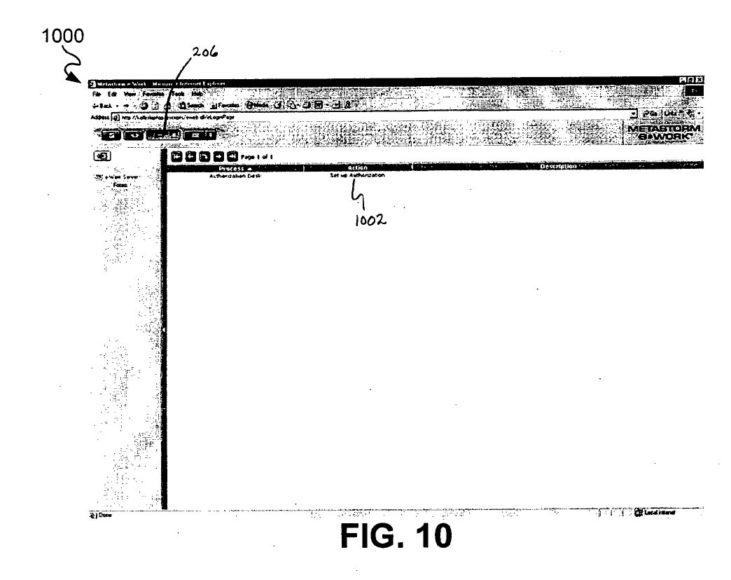

Personnel at a clinic (e.g., a doctor, a district surgeon, as well as other clinic personnel) may Log in to the system 400 and access a presentation of the graphical user interface 200. FIG. 10 is a schematic diagram of an illustrative version 1000 of the graphical user interface 200 that may be presented to a clinic's personnel after logging in to the system in accordance with an exemplary embodiment. Once logged in, the user may click on a Blank Forms list selection button 206 to view blank forms accessible to the clinic. From the blank forms listed, the user may selected a Set up Authorization form 1002 to start a new folder in the Authorization Procedure 900.

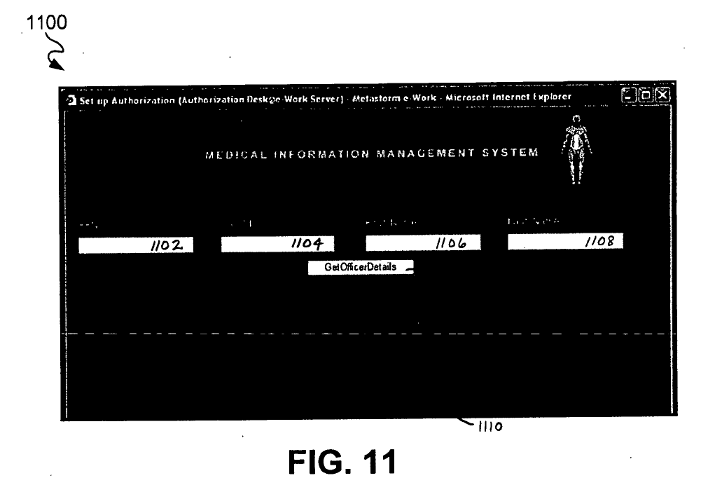

In response to the selection of the Set Up Authorization form 1002, an Officer Lookup form may be presented. FIG. 11 is a schematic diagram of an illustrative Officer Look Up form 1100 in an exemplary embodiment of an Authorization procedure 900. The Officer Look Up form 1100 may include a plurality of fields for receiving user input such as Officer's Social Security Number 1102, Tax ID 1104, First and Last Names 1106, 1108. A user may enter the Officer's Social Security Number, Tax ID or Name into one of the above mentioned fields and then selected Get Officer Details button 1110 to run a search of the system's database for entries matching the input.

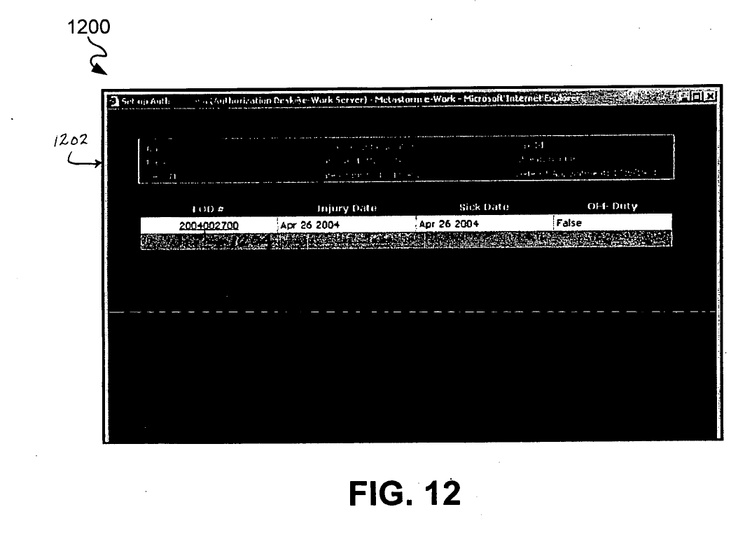

If matches are found by the system during the search, a table of search results may be presented to the user. FIG. 12 is a schematic diagram of an illustrative search result summary 1200 that may be displayed to a user via the graphical user interface 200 in response to a search initiated by the user. This summary 1200 may display the following information about a claimant/patient (see box 1202): SSN #, Tax ID #, Command #, Rank, Last Name, First Name, Middle Initial, Shield, Sex, Date of Birth and Date of Appointment. The summary may also include a user-selectable link 1204 for a LOD# (i.e., a claim number) associated with an line of duty injury/illness associated with the claimant. This link 1204 may be selected to set up an Authorization for the claimant.

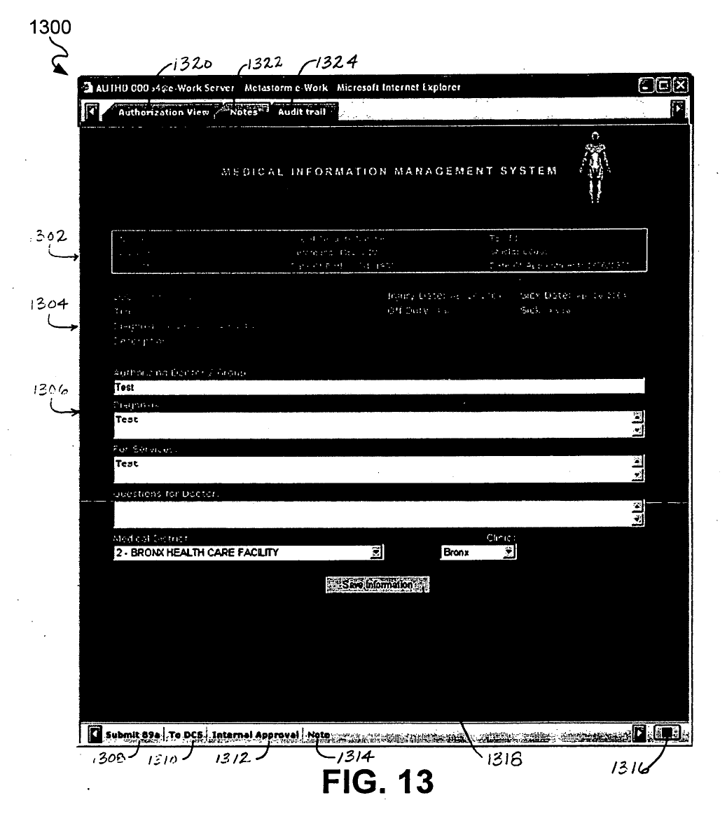

Selection of the link 1204 may cause the retrieval of information associated the claim and the display of an Authorization Request form for the claim. FIG. 13 is schematic diagram of an illustrative Authorization Request form 1300 that may be displayed via a graphical user interface in accordance with an exemplary embodiment. As shown in FIG. 13, an Authorization Request form. The form may include the following sections:

a) Member profile 1302—Populated with member (i.e., claimant) data extracted from the system, including various information about the claimant name, SSN #, Tax ID #, Rank, Command, Shield, Sex, Date of Birth and Date of Appointment. This information may be presented in a read-only format to prevent editing.

b) Injury details 1304—May be completed by the Line of Duty Procedure (see FIG. 4). Data may include auto-generated Line of Duty number, date and time injured, if injured off duty, if reported sick and date, diagnosis, and description of how injured. This information may be presented in a read-only format to prevent editing.

c) Authorization details 1306—Presents a plurality of fields for receiving input after a patient assessment. The fields may include:

i) Authorizing doctor or group;

ii) Diagnosis;

iii) Services requested;

iv) Questions for doctor;

v) Medical district; and

vi) Clinic.

In a case where more than one authorization may be required (e.g., surgery), a clinic may be required to submit a separate form for each authorization request. When user has completed the form 1300, the user may select an action button 1308, 1310, 1312, 1314 to submit the input to the system (and to various elements in the system) or to cancel out of the form at any time by selection of a cancel button 1316. Upon submitting the form, a user may receive an editable summary of the Authorization form (also referred to herein as an “89a form”). To save modifications to the form in the system, a user may select a Save Information button 1318 which initiates a command to save the information input into the form 1300.

The form may also display a plurality of tabs 1320, 1322, 1324 and, as previously mentioned, selections for initiating a plurality of actions. As shown in the illustrative embodiment in FIG. 13, tabs may be displayed along the top of the form 1300, and actions may appear at the bottom of the form. The displayed tabs may include: an Authorization View tab 1320, a Notes tab 1322, and an Audit Trail tab 1324. The displayed Action selections may include a Submit form selection 1308, a To DCS selection 1310, an Internal Approval selection 1312, and a Note selection 1314 (as well as the previously described cancel selection 1316).

The following paragraphs further describe a plurality of various views that may be presented to a user via the graphical user interface upon selection of the various tabs shown in FIG. 13.

Authorization View

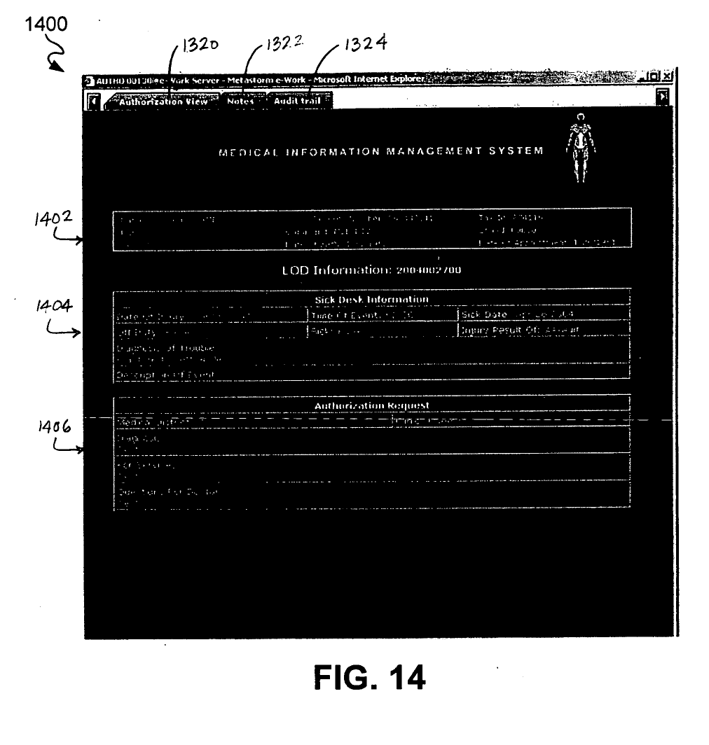

FIG. 14 is a schematic diagram of an illustrative Authorization View 1400 displayed via a graphical user interface upon selection of an Authorization View tab 2020 in accordance with an exemplary embodiment. The displayed Authorization View 1400 may provide a summary of the Authorization form prior to submitting it for approval.

Notes

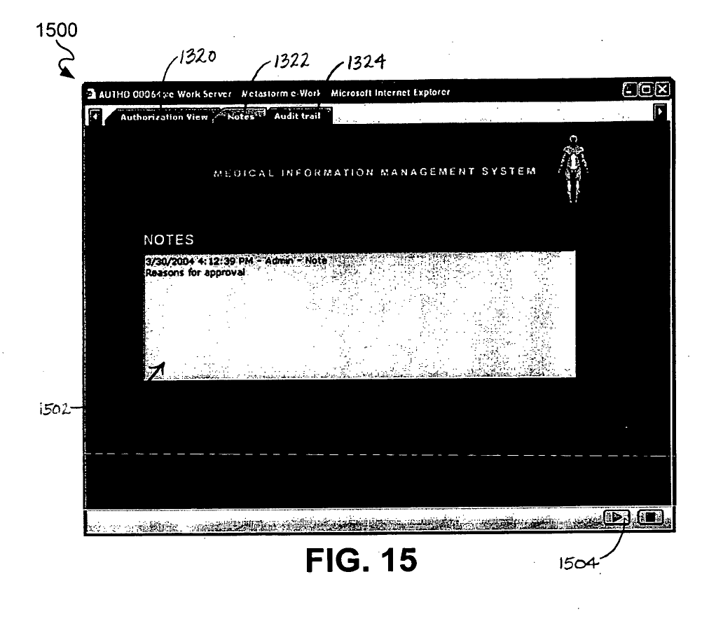

FIG. 15 is a schematic diagram of an illustrative Notes display 1500 that may be displayed via a graphical user interface upon selection of an Notes tab 2022 in accordance with an exemplary embodiment. The Notes display 1500 may display any previously entered remarks (e.g., remark 1502) that pertain to an associated folder.

Audit Trail

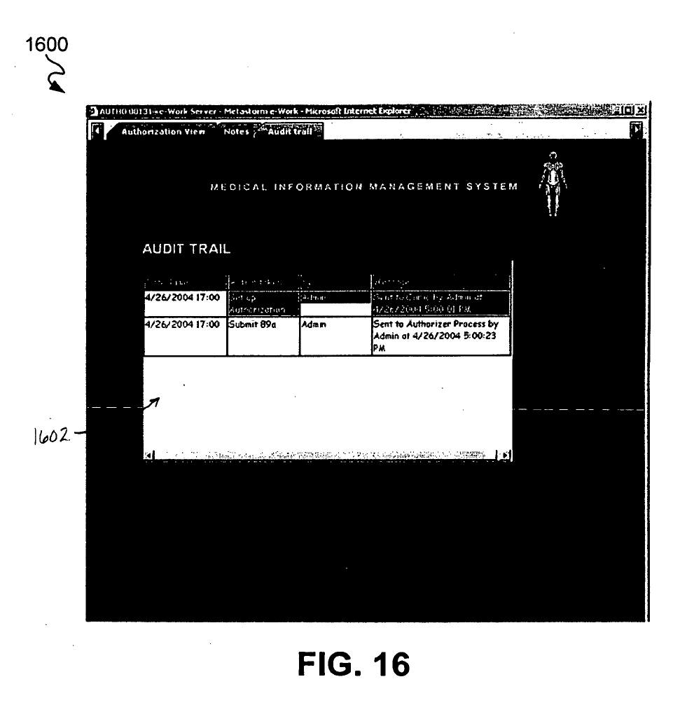

FIG. 16 is a schematic diagram of an illustrative Audit Trail display 1600 that may be displayed via a graphical user interface upon selection of an Audit Trail tab 2024 in accordance with an exemplary embodiment. The system may record information about each action taken on a folder. As shown in FIG. 16, the displayed Audit Trail may provide a log 1602 of each action taken on a folder, time and date of action, by whom the action was performed and a message.

Actions

The following paragraphs further describe the Actions presented to a user via display 1300 shown in FIG. 13. As shown in the illustrative embodiment, the Actions may appear at the bottom of the form.

Note Action Selection 1314

The Note action 1314 may be used to mark down special information or questions for the Deputy Chief Surgeon (e.g., at elements 906 and 910). Selecting the Note action button 1314 may result in the system presenting the Note display 1500 into which a user may enter comments, questions, etc in the displayed text area 1502. The user may then select a Submit button 1504 to save the notes to the system.

To DCS Action Selection 1310

By selecting the To DCS action 1310, the clinic staff may route a folder to the To Do list of a Deputy Chief Surgeon 906 for a second opinion (e.g., Action 924 of FIG. 9). The Note action allows a user to submit comments or questions with the folder.

Selecting the To DCS action button 1310 routes the folder to the DCS for review (i.e., action 924 of FIG. 9). The DCS receives the notes and summary for review. The DCS may either approve or disapprove the authorization, note reasons and resubmit the folder back to the clinic's To Do list (via action 928 of FIG. 9).

Internal Approval Action 1312

A Clinic may approve a pre-defined list of services without going through the Authorization Desk. In accordance with one embodiment, When a user selects the Internal Approval action 1312, the system may display the user with a list menu (e.g., a drop-down menu) via the graphical user interface for the user to select a service presented in the list. The user may then select a service from the menu and select a Submit button to grant the approval. Upon submitting the internal reason, a printable version of the Authorization may be opened in the graphical user interface. The Authorization may include a bar code, which represents the Authorization Number for the approved services.

Submit Form Action 1308

The Submit Form action 1308 is the final action after the authorization request has been reviewed by the District Surgeon and if necessary, the Deputy Chief Surgeon. At this point, the authorization request is ready to be sent to the Authorization Desk 908 for processing (via action 922 of FIG. 9).

When a user selects the Submit Form action 1308, the system may display a confirm action dialog box to the user. To confirm the action, the user may then select a Submit button. To cancel the action and return to the form, the user may select a cancel action button displayed via the graphical user interface. After selecting the Submit button, the authorization form may then be sent to the To Do list of the Authorization Desk (e.g., via action 922 of FIG. 9).

Tracking Requests

To monitor the status of requests once they have left a user's queue, a user select a Watch List selection button presented in a graphical user interface. Upon receipt of such a selection, the system may then display a Watch List to the user via the graphical user interface.

The Watch List may be similar to a To Do list and may display folder name, subject (LOD Number and Services), date last updated, current stage, priority level, deadline, and a message displaying last action taken. Selecting an item in the Watch List permits a user to review the contents of the folder. The Watch List include a summary with additional tabs to the Notes and Audit Trail. From this view, a user may be able top determine where a given folder currently resides (i.e., which role is currently handling the file), who has reviewed it and any notes that have been made.

Approval

When an Authorization Desk approves the request for services (e.g., action 908 of FIG. 9), notice of an approved Authorization may be sent back to the originator's (e.g., clinic's) To Do list. From the list, the subject indicates the LOD Number and services for the member. Last updated and alert message columns show when the authorization was sent and who approved it. To open an approved Authorization from a To Do List, a user may select a link associated with the authorization in the To Do list. The Authorization View may then displayed with an action to Print and Archive.

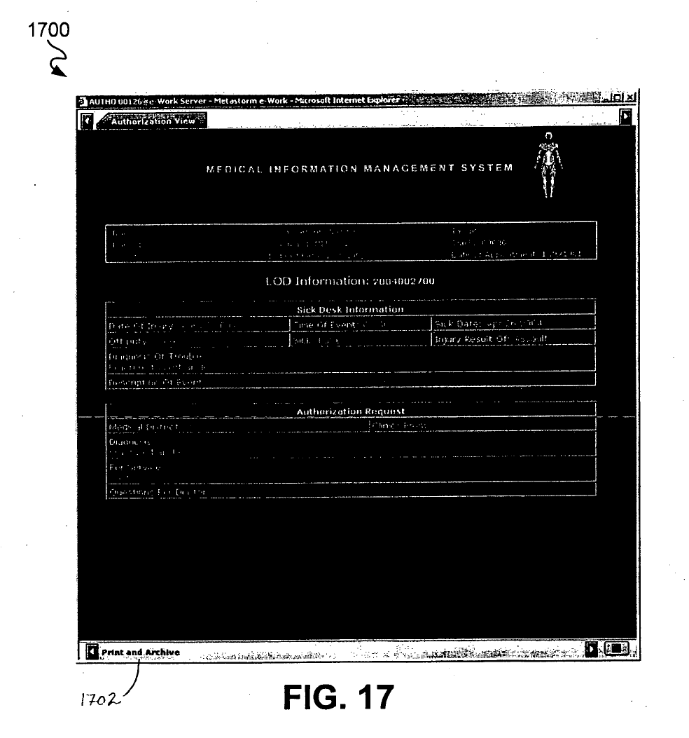

FIG. 17 is a schematic diagram of an illustrative Authorization View 1700 that may be presented after selection of a link in a To Do List associated with an approved authorization in accordance with an exemplary embodiment. The Authorization View 1700 may display a Print and Archive action button 1702. Upon selection of the Print and Archive action button 1702 by a user, the system may display a printable version of the Authorization form.

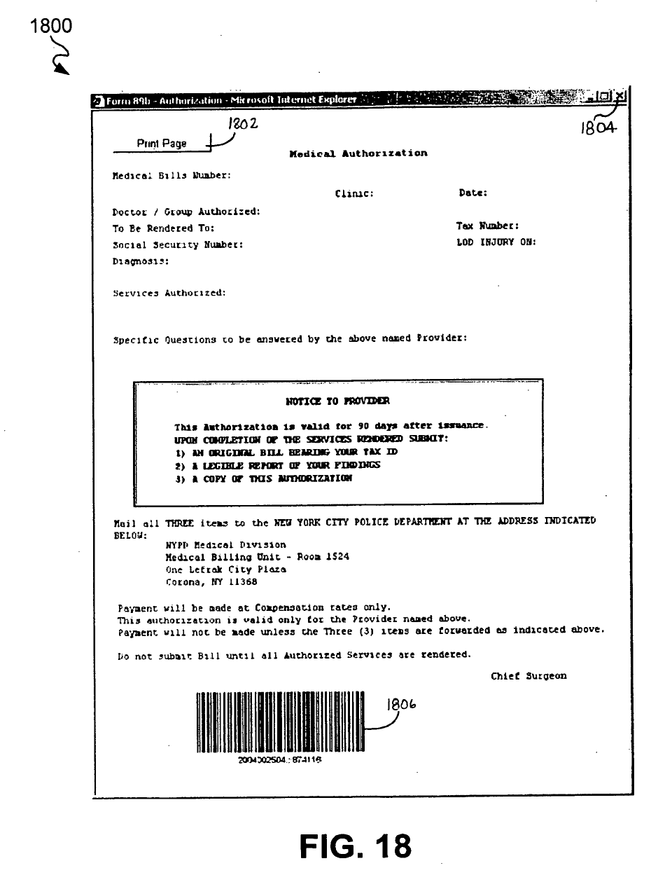

FIG. 18 is a schematic diagram of an illustrative printable version of an Authorization form 1800 that may be displayed in response to selection of the Print and Archive action button 1702 of the Authorization View 1700 in accordance with an exemplary embodiment. The page 1800 may include a “Print Page” button 1802 and a bar code 1804 for the Authorization Number associated with the folder and that allows a Medical Division to automatically match incoming bills with an Authorization in the system. Selection of the Print Page button may cause printing of the Authorization form 1800 to a printer coupled to the system (e.g., via action 946 of FIG. 9). Selection of an “X” selection 1806 in the upper right-hand corner of the form 1800 may cause the form to be to close the form and automatically archive the record in the member's electronic folder (see action 946 of FIG. 9). The clinic may then issue the printed 89b to the authorized member (i.e., the claimant).

As shown in FIG. 9, both approved and disapproved authorizations may go into the archive 918 after a waiting period. The waiting period allows users to view the folder's status from the Watch List before it is permanently filed by the system.

Authorization Desk 908 Role in an Authorization Procedure

The following paragraphs describes how an Authorization Desk clerk at an Authorization Desk 908 may interact with the system to process authorization requests for services. The Authorization Desk 908 may receive tasks from many sources in the Authorization process 900. For example, the Authorization Desk 908 may receive tasks from:

a) District clinics (e.g., clinic 904)—when an authorization request is being made;

b) Supervising surgeons (e.g., DCS 910 and/or Ortho 912)—when an authorization request is under review; and

c) Hold queue 916—when a folder returns to the To Do list either automatically after a set number of days or when it is retrieved manually.

After logging into the system, the system may present a user at an Authorization Desk 908 (hereinafter simply referred to as the Authorization Desk 908) may with a main display of a graphical user interface (e.g., graphical user interface 200 of FIG. 2). The Authorization Desk 908 may then select a To Do list selection button presented in the graphical user interface to present a selectable list of folders in the Authorization Desk's To Do List. The Authorization Desk 908 may then select one of the folders to via view the contents of a folder, click on the task in the To Do list. In response to the selection, the system may then present the corresponding Authorization form to the Authorization Desk via the graphical user interface. The presented Authorization form may be similar to that depicted in FIG. 17 and may include a plurality of Tabs (that may be displayed along the top of the form 1700 and a plurality of actions displayed at the bottom of the form 1700.

In an exemplary embodiment, the tabs of an Authorization form displayed to an Authorization Desk may include:

a) Authorization View;

b) Notes; and

c) Audit Trail.

In an exemplary embodiment, the actions of an Authorization form displayed to an Authorization Desk may include:

a) Note;

b) To DCS;

c) To Ortho;

d) Hold;

e) Disapprove; and

f) Approve.

Selection of the Authorization View action loads by default, and provides a summary of the Authorization Request form as shown in FIG. 17. As previously discussed, the Authorization form may include has three sections including a Member profile section, an Injury detail section and an Authorization Details section. The Notes tab may be selected to display a history of related notes that may have been added to the folder by any of the roles assigned to this procedure. Selection of the Audit Trail tab may displays a log of each action taken on a folder, time and date of action, by whom the action was performed and an optional message.

Actions

Selectable actions that may be presented to (and selected by) the Authorization Desk in the Authorization View may include: a Note action, a To DCS action, a To Ortho action, a Hold action, a Disapprove action, and an Approve action. The note action may be performed in a similar manner as that previously described for the Clinic.

To DCS/To Ortho Actions

As shown in FIG. 9, an Authorization Desk may route a folder to the To Do list of the Deputy Chief Surgeon 910 or the Orthopedic Surgeon 912 for a second opinion (via actions 926 and 932 respectively). After notes (if any) have been added to the folder by the Authorization Desk, the Authorization desk may submit the Authorization form/folder to the DCS 910 or Ortho 912 by selecting either the displayed To DCS action button or the To Ortho action button to route the folder with notes to the appropriate place.

The DCS/Orthopedic surgeon receives the task in his queue marked with the date and origin. The DCS/Orthopedic surgeon may then approve or disapprove the authorization, note reasons and resubmit the folder back to the Authorization Desk's To Do list (as shown via actions 930 and/or 9034 of FIG. 9).

Hold Action 938

In some cases, the Authorization Desk may find it necessary to hold a folder until more information is available before granting authorization (or disproval). To initiate the placement of a folder in the Hold Queue (i.e., action 938), the Authorization Desk may select a Hold action button displayed in the graphical user interface.

In accordance with one embodiment, Hold items (i.e., folders in a Hold queue 916) may automatically return to the Authorization Desk's To Do list in a pre-set number of days (see action 940 in FIG. 9). The Alert Message column of the graphical user interface displayed to the Authorization Desk may then indicate that the task has been returned from the hold queue.

To manually retrieve an item from the Hold queue, click on the Watch List selection button to display open tasks. Open the task you would like to return and submit it back to the main queue.

Disapprove Action

To disapprove a request for authorization, the Authorization Desk 908 may select a Disapprove action. A confirm action dialog box may then be presented to require the Authorization Desk to confirm or cancel the disapproval. After issuing of the Disapprove action, the folder may be routed into the archive 918 (see action 944 of FIG. 9) with its Audit Trail being updated to reflect the disapproval.

Approve Action

To approve and issue an authorization, the Authorization Desk may select the Approve action. Like the Disapproval action, a confirm action dialog box may then be presented to require the Authorization Desk to confirm or cancel the action. After selection of the Approve action, a printable version of the Authorization form (e.g., Authorization form 1800 of FIG. 18) may be routed to the originating clinic. As previously mentioned, the Authorization form 1800 may contain a bar code 1804 that represents a Authorization Number assigned to the approved service(s) and allows a Medical Division to automatically match incoming bills with a corresponding Authorization in the system.

DCS/Ortho Roles in the Authorization Procedure

As shown in FIG. 9, a Deputy Chief Surgeon (DCS) 906/910 and an Orthopedic Surgeon (ORTHO) 912 may utilize the system to respond to requests made by Clinics 904 and an Authorization Desk 908. The DCS and/or the ORTHO may receive tasks from two stages in the Authorization process: a) from a Clinic—when an authorization request is being made (e.g., action 924); and b) from an Authorization Desk—when an authorization request is being reviewed (e.g., actions 926 and 932). In terms of the system, these tasks may be handled in a similar manner.

The system may provide the DCS and/or ORTHO via a graphical user interface an authorization summary and notes. The system may then require the DCS and/or ORTHO with a decision (with supporting reason(s)) to be sent back to the originator.

The graphical user interface 200 may be presented to a DCS and/or ORTHO after logging into the system. Once logged in, the system may present the DCS and/or ORTHO (via a graphical user interface) an associated To Do list from which the DCS and/or ORTHO may select folders for their review. This may be accomplished in a similar fashion as previously described for the Clinic and the Authorization Desk.

For example, the system may utilize a graphical user interface 200 to present to the DCS and/or ORTHO a plurality of views including. Authorization View (e.g., Authorization View 1400 of FIG. 14), a Notes display (e.g., Note display 1500 of FIG. 15), and an Audit Trail display 1600 of FIG. 16).

The system may present via the graphical user interface a plurality of tabs for permitting a DCS and/or ORTHO to selectively choose between the various views/displays. For example, as shown in FIG. 1400, the tabs presented to the DCS and/or ORTHO may include an Authorization View tab 1320, a Notes tab 1322 and an Audit Trail tab 1324. The system may also display via the graphical user interface presented to the DCS and/or ORTHO user selectable Note action and Submit Decision Action buttons for initiating a Note action and a Submit Decision Action.

As shown in FIG. 14, the Authorization View may be presented as a default display in the graphical user interface to the DCS and/or ORTHO and provides a summary of the Authorization Request forms. As previously mentioned, the Authorization form 1400 may include three sections: a Member profile section 1402,—populated with member data extracted from the system (e.g., name, SSN #, Tax ID #, Rank, Command, Shield, Sex, Date of Birth and Date of Appointment), an Injury details section 1404—Completed by the Line of Duty Procedure (see FIG. 4) (Data of the Injury details section may include, for example, auto-generated Line of Duty number, date and time injured, if injured off duty, if reported sick and date, diagnosis, and description of how injured); and an Authorization details section—May be filled in by the clinic 904 following a patient/claimant assessment. By the clinic.

As shown in FIG. 1500, the Notes display 1500 may offer an open text area for remarks relating to the member. The originator may have included notes or questions in this area. Each note may include a date/time stamp.

As shown in FIG. 16, the Audit Trail display may provide a log of each action taken on a folder, time and date of action, by whom the action was performed and an optional message.

Via the graphical user interface, the DCS and/or ORTHO may a Note action. The Note action may be used by the DCS and/or ORTHO to record an opinion pertaining to the request. A note may be entered into the system in the manner previous described under FIG. 15.

A Submit Decision action by the DCS and/or ORTHO sends the folder back to the originator's To Do list (see FIG. 9, actions 928, 930 and 934). After the DCS and/or ORTHO has finished entering a decision/notes, into the folder, the DCS and/or ORTHO may select a Submit Decision action button displayed at the bottom of the Authorization form. A confirm action dialog box may then appear to obtain confirmation (or cancellation) from the DCS and/or ORTHO prior to submitting the decision to the system.

After confirmation, the folder leaves the To Do list of the DCS/ORTHO role and moves back to the queue of the originating clinic. For folders returned from the DCS and/or ORTHO, the system will then indicate in the Alert Message column of the To Do list displayed to the clinic that a decision has been submitted by a DCS and/or ORTHO and the date of the submission.

Bill Payment

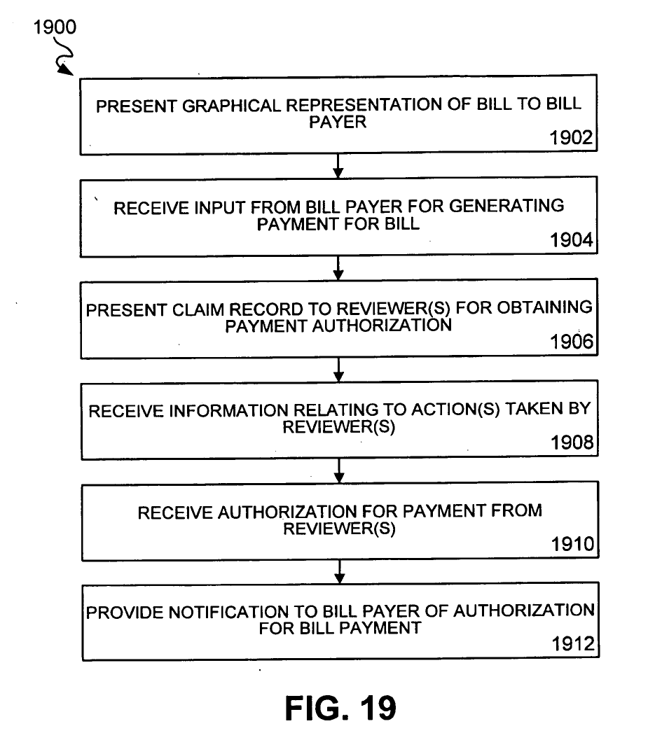

FIG. 19 is a flowchart of a process 1900 for authorizing payment of a treatment in accordance with an embodiment of a claim processing system.

A graphical representation (i.e., an image) of a bill received for a service performed on a claimant may be presented to a bill payer in operation 1902. In one embodiment, the graphical representation of the bill comprises a captured digital image obtained from a paper version of the bill scanned by an optical scanning device. The bill may be associated with an authorization for an authorized claim by the claimant. The graphical representation of the bill may be presented with information from a record associated with the claim and both the record and the graphical representation of the bill may be retrieved from a database. In one implementation, the graphical representation of the bill and the information from the record may be presented to a bill payer in a graphical user interface via a network.

Input may then be received from the bill payer for generating a payment for the bill in operation 1904. The input may be entered into the graphical user interface by the bill payer and the input may be obtained from the presented graphical representation of the bill and the information from the record. The input may be received from the bill payer via the network. The record may then be updated to include the input for generating the payment for the bill.

Via a graphical user interface, information from the record may be presented to one or more reviewers in operation 1906 so that the reviewers may review the information from the record to determine whether to authorize the payment of the bill. The information from the record may be presented to the reviewer via the network.

Each reviewer may be required to perform an action (i.e., some kind of response) relating to the payment of the bill within a predefined amount of time (see operation 1908). The action taken by a reviewer may be input into a graphical user interface by the reviewer so that information relating to the action may be transmitted may be sent via the network so that the record in the database can be updated with to include this information.

One action that a reviewer may perform is authorizing payment of the bill. When an authorization for payment of the bill is received from the reviewer in operation 1910, a notification may be provided to the bill payer (and/or a service provider and/or a reviewer) to indicate receipt of the authorization for payment of the bill from the reviewer (see operation 1912).

Further details of an bill payment procedure will now be described with use of the following illustrative Bill Payment Procedure in accordance with an exemplary embodiment.

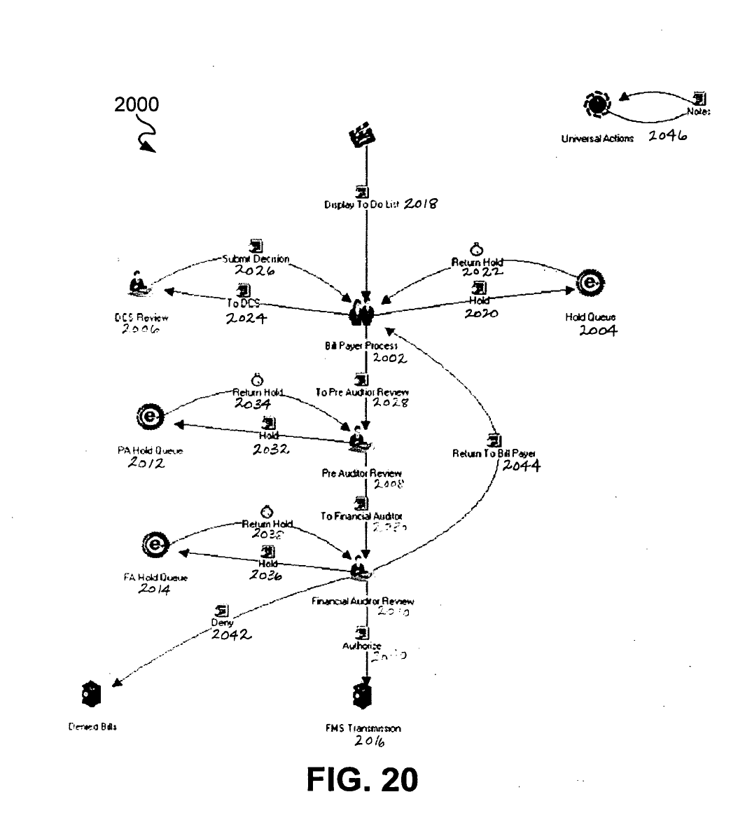

FIG. 20 is a schematic process flow diagram of an illustrative bill payment procedure 2000 in accordance with an exemplary embodiment. The Bill Payment procedure 2000 set forth in FIG. 20 illustrates the process flow of an electronic bill payment procedure from arrival of an incoming bill to the final transmission to a Financial Management System (FMS). The Bill Payment procedure 2000 may include a plurality of stages, actions, forms and roles.

Stages

As set forth in FIG. 20, the stages of a Bill Payment procedure 2000 may include:

a) Bill Payer Process stage 2002;

b) Bill Payer Hold Queue 2004;

c) Deputy Chief Surgeon (DCS) Review stage 2006;

d) Pre Auditor Review stage 2008;

e) Financial Auditor Review stage 2010;

f) Pre Auditor (PA) Hold Queue 2012;

g) Financial Auditor (FA) Hold Queue 2014; and

h) FMS Transmission stage 2016.

Actions

As shown in the illustrative process flow of FIG. 20, a Bill Payment procedure 2000 may include a plurality of actions, such as:

a) Display To Do List (process kick-off) 2018;

b) Hold 2020;

c) Return Hold; 2022;

d) Send to DCS 2024;

e) DCS Submit Decision 2026;

f) To Pre Auditor 2028;

g) To Financial Auditor 2030;

h) Send to Pre Auditor Hold Queue 2032;

i) Return from Pre Auditor Hold Queue 2034;

j) Send to Financial Auditor Hold Queue 2036;

k) Return from Financial Auditor Hold Queue 2038;

l) Authorize 2040;

m) Deny 2042;

n) Return to Bill Payer 2044; and

o) Add Notes, View Notes, and View Audit Trail 2050 (Universal Actions 2046).

Electronic Forms

During implementation of a Bill Payment procedure 2000, the system may generate and display via a graphical user interface (e.g., graphical user interface 200) a plurality of electronic forms (also referred to as views or windows) including:

a) Display To Do List (New Bill Lookup);

b) Complete Information;

c) Provider and Bill Information;

d) Procedure Codes; and

e) Note.

Roles

There are a plurality of roles (i.e., users) involved in the various stages of a Bill Payment procedure 2000. These roles may be involved in initiating and/or performing the various actions of the procedure 2000. These roles may include:

a) Bill Payer (associated with the Bill Payer Process stage 2002);

b) Deputy Chief Surgeon (involved in the DCS Review stage 2006);

c) Pre Auditor (involved in the Pre Auditor Review stage 2008); and

d) Financial Auditor (involved in the Financial Auditor Review stage 2010).

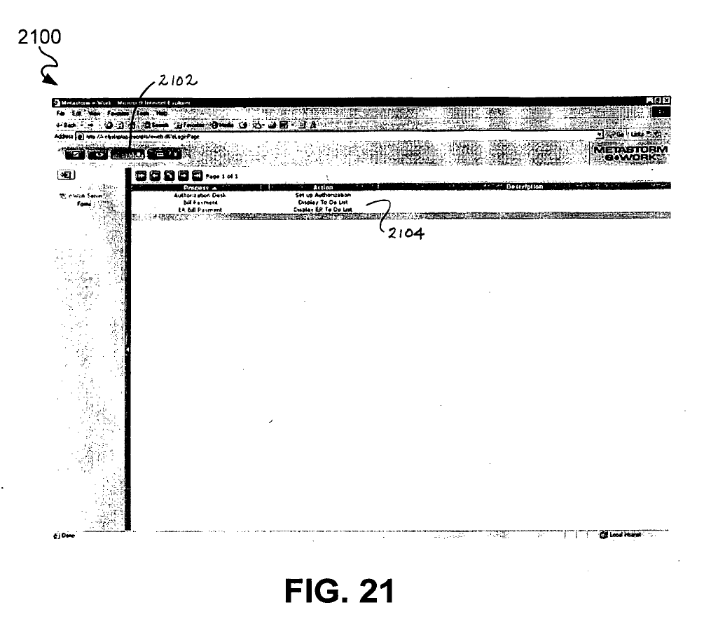

Each of the roles in the Bill Payment procedure 2000 may log into the system to access information from system for helping to carry out the Bill Payment procedure. After logging into the system, each of the roles may be presented with a main window of a graphical user interface for use in a Bill Payment procedure 2000. FIG. 21 is a schematic diagram of an illustrative version of a main window 2100 of a graphical user interface for use in a Bill Payment procedure 2000 in accordance with an exemplary embodiment. As shown in FIG. 21, the main window of the graphical user interface 2100 may comprise a version of the main window of the graphical user interface 200 depicted in FIG. 2 that is customized by the system to meet the needs of the various roles in the Bill Payment procedure 2000 while retaining the general layout and commands presented in the version depicted in FIG. 2.

The following paragraphs describe particular aspects of the various roles in the Bill Payment procedure 2000.

Bill Payer Role

As shown in FIG. 20, the Bill Payer may be associated with the Bill Payer Process stage 2002 of a Bill Payment procedure 2000. After logging into the system, the Bill Payer may initiate the Bill Payer procedure 2000 by displaying a To Do list (see action 2018). In accordance with an exemplary embodiment, displaying the To Do list by a Bill Payer may be accomplished by selecting a Blank Forms list selection button 2102 that is similar to the Blank Form list selection button 206 of FIG. 2. After receiving an indication that the Blank Forms list button 2102 has been selected by the Bill Payer, the system may then present in the main window 2000 user selectable links for various blank forms used in various processes/actions in the Bill Payment procedure 2000 associated with the Bill Payer role. As shown in FIG. 21, a Bill Payer may select a Bill Payment—Display To Do list link 2104 to start the bill payment process 2000.

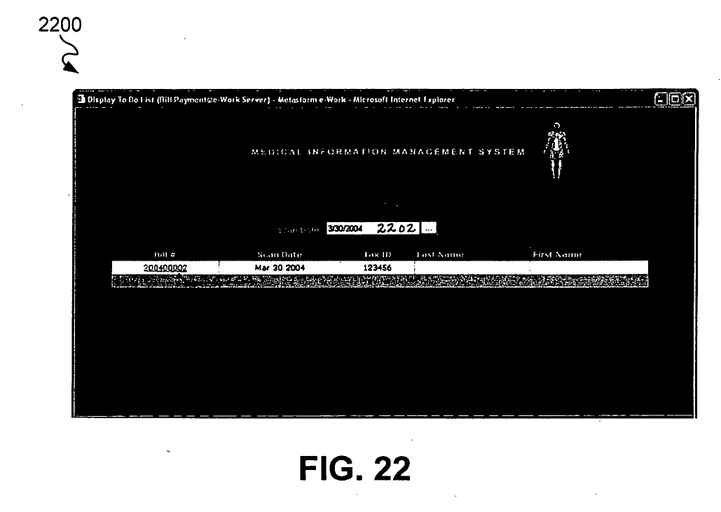

After selecting the Bill Payment—Display To Do list link 2104, the system may present the Bill Payer with a New Bill lookup window of the graphical user interface. FIG. 22 is a schematic diagram of an illustrative a New Bill lookup window 2200 of a graphical user interface for use in a Bill Payment procedure in accordance with an exemplary embodiment. The New Bill lookup window 2200 may include a field 2202 (e.g., a textbox) into which a Bill Payer may enter a date in order to retrieve from the system all bills scanned into the system on that particular date.

After receiving the input date, the system may then conduct a search for bills scanned into the system. If matching entries are found during the search, the system may present a table of search results 2204 below the Scan Date in the Bill lookup window 2200. The table 2204 may include a fields associated with the matches found during the search. As shown in the exemplary window 2200, the displayed fields may include Bill #, Scan Date, Tax ID, Last Name, and First Name. The Bill# field (or any other field) may comprise a user-selectable link.

In order to process a bill identified in the list 2204, a Bill Payer may selecting the link (e.g., the Bill# link) to the appropriate entry (e.g., by selecting the Bill# link). In response to the selection, the system may then retrieve information associated with the selected Bill# and present a Bill Payment Screen to the Bill Payer via the graphical user interface.

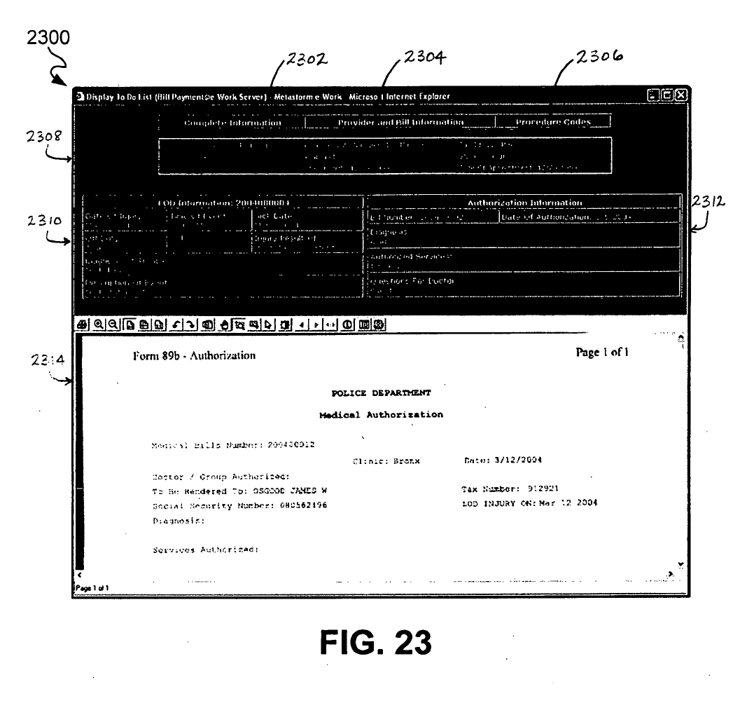

FIG. 23 is a schematic diagram of an illustrative Bill Payment Screen 2300 in accordance with an exemplary embodiment. As shown in FIG. 23, a Bill Payment Screen 2300 may comprise a plurality of areas including, for example:

a) Tabs—The Bill Payment Screen 2300 may include a plurality of user-selectable tab links for providing links to Complete Information 2302 (which may be a default view initially presented to a Bill Payer), Provider and Bill Information 2304, and Procedure Codes 2306. As shown in FIG. 23, the tabs may be presented in the graphical user interface at the top of the screen 2300.

b) Member Profile—Another area that the Bill Payment Screen 2300 may include is a Member Profile area 2308 that may be populated with member data extracted from the system including, for example: name, SSN #, Tax ID #, Rank, Command, Shield, Sex, Date of Birth and Date of Appointment.

c) Injury Details—An Injury Details area 2310 may be presented in the Bill Payment Screen 2300. The information presented in the Injury Details 2310 may be provided to the via from a Line of Duty Procedure. Data in the Injury Details 2310 may include auto-generated Line of Duty number, date and time injured, if injured off duty, if reported sick and date, diagnosis, and description of how injured.

d) Authorization Details—a fourth area of the Bill Payment Screen 2300 may comprise an Authorization Details area 2312. The information in the Authorization Details 2312 may be submitted by the Clinic following a patient assessment and approved by the Authorization Desk (see Authorization Procedure).

e) Document Image—The Bill Payment Screen 2300 may further include an area 2314 for presenting a view of an imaged Authorization form, a provider bill, and/or physician's findings. The images may be stored in a Document Repository of the system.

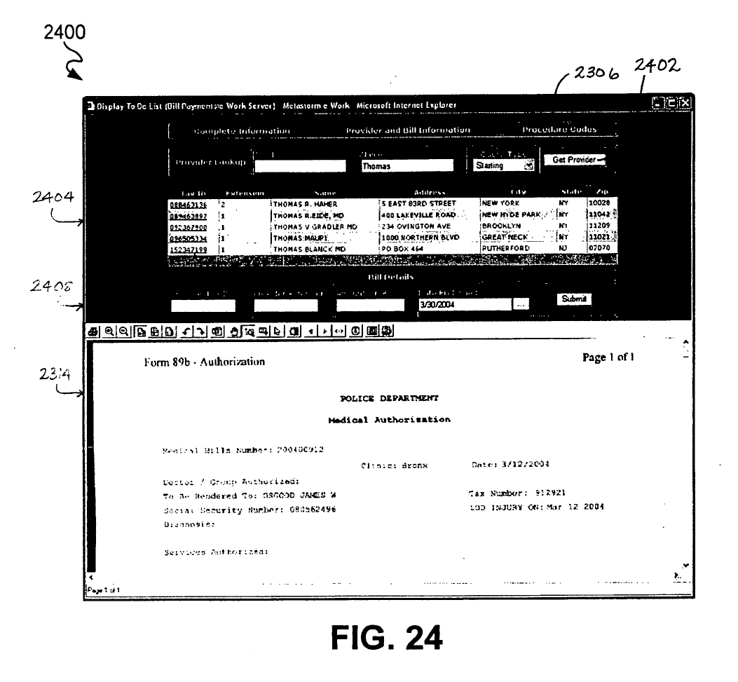

A Bill Payer may select the “Provider and Bill Information” tab 2304 to access a Provider Lookup form in the graphical user interface for entering details from the bill image presented in the Document Image area 2314. FIG. 24 is a schematic diagram of an illustrative embodiment of a Bill Payment screen 2300 displaying a Provider Lookup form 2402 in response to selection of the “Provider and Bill Information” tab 2304 in accordance with an exemplary embodiment. The Provider Lookup form 2402 may include a plurality of input fields for receiving input by a user for use in conducting a search of the system for provider and bill information.

Using the Provider Lookup form 2402, a user may enter a Provider's Tax ID or Name, select a Query Type (e.g., exact match), and select a Get Provider button to initiate a search by the system for information matching the search terms input into the form 2402. Providers matching the search criteria may then be presented by the system to appear in a table 2404 below the search form 2402. To select one of the listed providers, a user may select a Tax ID number link (e.g., link 2406) associated with the desired provider. The system may then retrieve information about the selected Provider and use this information to populates a textbox in a Bill Details area 2408 of the form 2300.

As shown in FIG. 24, the Bill Details area 2408 may include a plurality of fields (e.g., textboxes) adapted for receiving input from a user (e.g., a Bill Payer). Into the appropriate fields of the Bill Details area 2408, a Bill Payer may enter a total amount on the bill and an issue date of the bill select a Submit button 2410 to submit the input information to the system.

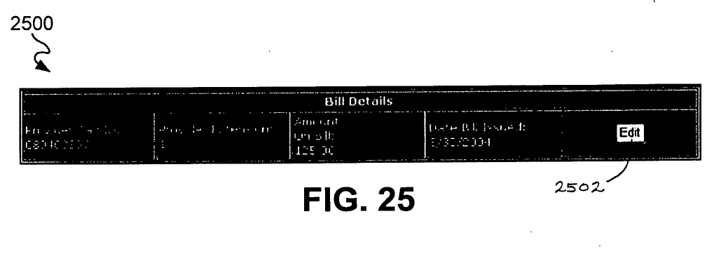

After submitting the form (via Submit button 2410), the Bill Details area 2408 may change to a read only view. FIG. 25 is a schematic diagram of an read only version 2500 of a Bill Details area 2408 in accordance with an exemplary embodiment. To modify the bill details displayed in a read only Bill Details area 2500, a Bill Payment may select an Edit button 2502 presented in the Bill Details area 2500. This reverts the Bill Details area 2500 back into an editable version 2408 into which edits can made to the input. When the edits are completed, the Bill Payer may then select the Submit button 2410 to save the edits in the system.

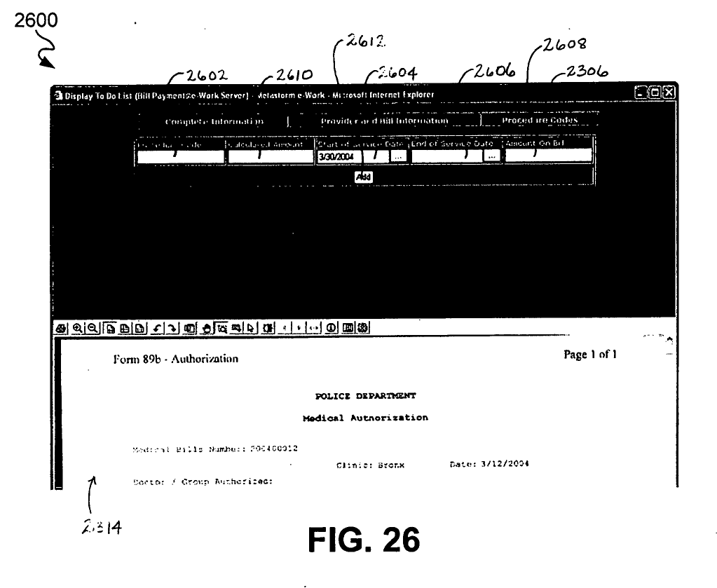

To enter specific procedure codes from the bill image, a Bill Payment may select the Procedure Codes tab 2306 (see FIG. 23). FIG. 26 is a schematic diagram of an illustrative Procedure Codes form 2600 that may be presented to a Bill Payer in the Bill Payment Screen 2300 after selection of the Procedure Codes tab 2306 in accordance with an exemplary embodiment. The Procedure Codes form D900 may include a table for entering each service rendered and calculating the amount to pay. Below the Procedure Codes form 2600, an image of the corresponding bill may be displayed in the Document Image area 2314. Using the bill image in the bottom frame 2314, a Bill Payer may enter the following into the textboxes provided: Procedure Code 2602, Start and End of Service Dates 2604, 2606, and Amount on Bill 2608. The system may then compute (e.g., via an auto-complete feature) a Calculated Amount field 2610 based on the Procedure Code entered. The Bill Payer may then verify that the code has been entered correctly. To key in additional services, the Bill Payer may select an Add button 2612 and follow repeat the steps described above.

When the Bill Payer has completed entering all of the procedure codes, the Bill Payer may then select a Submit button to submit the input information to the system. In response to the selection of the Submit button, the system may then open a bill payment summary form. At this stage, the system will present a Bill Payment Summary form with the following tabs and actions in the graphical user interface (tabs may be displayed along the top of the form, actions may appear at the bottom of the form):

a) Tabs: a Bill Payment View tab, a Notes tab, and an Audit Trail tab.

b) Action's: a To Financial Auditor action selection, a Hold action selection, a Note action selection, and a Return to Bill Payer action selection.

Tabs

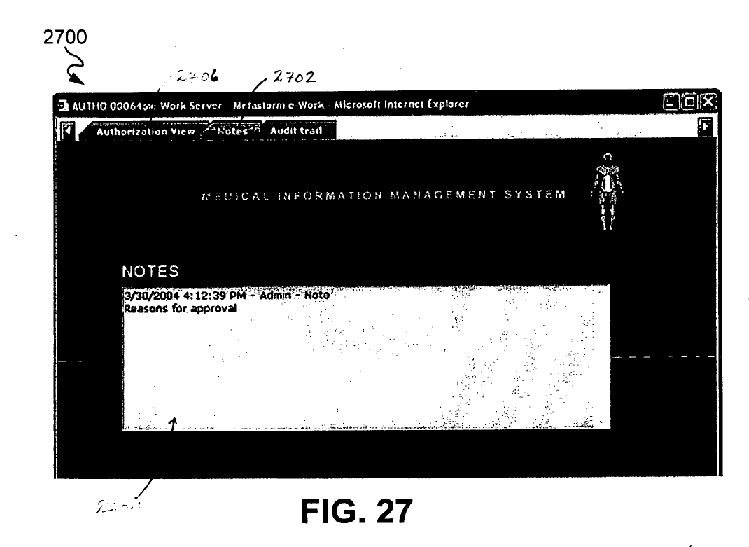

FIG. 27 is a schematic diagram of an illustrative Notes form 2700 of a Bill Payment Summary form presented by the system to a Bill Payer via a graphical user interface after selection of a Notes tab 2702 in the Bill Payment Summary form in accordance with an exemplary embodiment. The Notes form 2700 offers an open text area 2704 displaying remarks entered about the case. Selection of the Bill Payment View tab 2706 may open (by default) to provides a summary of the billing details.

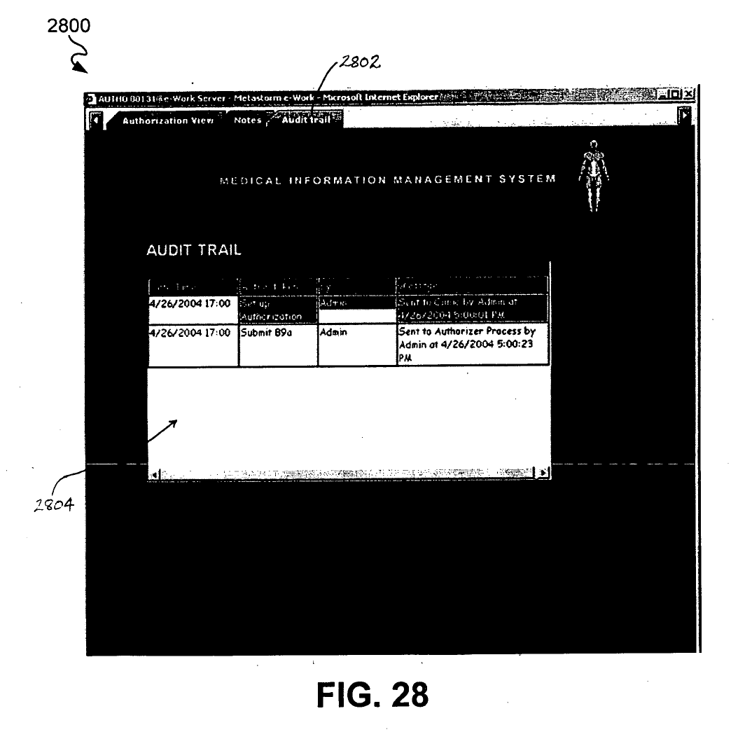

FIG. 28 is a schematic diagram of an illustrative Audit Trail form 2800 presented by the system to a Bill Payer via a graphical user interface after selection of an Audit Trail tab 2802 in the Bill Payment Summary form in accordance with an exemplary embodiment. The Audit Trail form may provide a log 2804 of each action taken on a folder, time and date of action, by whom the action was performed and a message.

Actions

Note Action

The Note action may be used to mark down special information or questions for the DCS. In order to execute a Note action, a user may select the Note action selection to launch the open text form 2704. The user may then enter comments or questions in the text area. The user may then select a Submit button to save the notes to the system.

To DCS Action

Bill Payers may route a folder to the To Do list of the Deputy Chief Surgeon for a second opinion via selection of a To DCS Action selection. The Bill Payer may use the Note action to submit comments or questions with the folder prior to the DCS. After selection of the To DCS Action selection, the system will include the task in the DCS's queue marked with the date and origin. The DCS may then approve or disapprove the procedure, note reasons and resubmit the folder back to the Bill Payer's To D o list.

Hold Action

In some cases, it may be necessary to hold a folder until more information is available. To put a folder in the Hold Queue, a user may select a Hold action selection. The system may be implemented so that Hold items may automatically return to the user's To Do list in a pre-set number of days. The Alert Message column will indicate that it is a task returned from the hold queue. To manually retrieve an item from the Hold queue, a user may select on a Watch List selection button to display open tasks. The user may then open a task that the user wishes to return and submit it back to the main queue.

To Pre-Auditor Review Action selection

Once a Bill Payer has entered the bill payment and provider details and received the necessary approvals, the folder may then be forwarded to a Pre-Auditor for review. To do so, the Bill Payer may select a To Pre-Auditor Review action selection presented via the graphical user interface. The system will then send the folder to the queue of the Pre-Auditor where Vendor details may be verified.

Bill Tracking

At this point, the request has been routed to the Pre-Auditor's To Do list. To monitor the status of requests, a Bill Payer may select on a Watch List selection button presented to the Bill Payer via the graphical user interface. For identification purposes, the Watch List may display folder name, subject (member name and tax ID), date last updated, current stage, priority level, deadline, and a message displaying last action taken. A Bill Payer may select an item displayed in the Watch List to review the contents of a folder. From the Watch List view, a user may determine if a bill has been processed to completion. The Audit Trail and Notes tabs show a complete history of who handled the folder, when an action was performed on it and any notations made by the auditors.

Pre Auditor Role

A function of a Pre-Auditor 2008 is to review and correct inaccurate vendor information to ensure that payment is sent to the correct group/individual and location. The Pre-Auditor may use the system to access work from a To Do list of a graphical user interface presented to the Pre-Auditor. The Pre-Auditor may then be able to process all of his/her tasks electronically, from receiving tasks through the system, to administering vendor changes with a Vendor Management Utility, to forwarding processed bills on to the Financial Auditor for final review.

Once a Pre-Auditor is logged in and has selected a To Do list selection button of the graphical user interface, a To Do List may be presented that includes list of tasks for the Pre-Auditor to complete. The Pre-Auditor may select on a task in the To Do List to review the details of the associated folder. This causes the system to present a bill payment summary of the folder to the Pre-Auditor. At this stage, the system may present the Pre-Auditor with following tabs and actions (with tabs displayed along the top of the form and actions appearing at the bottom of the form).

Tabs: Bill Payment View, Notes, Audit Trail

The Bill Payment View provides a summary of the details submitted by a bill payer. The Notes tab offers an open text area for remarks relating to the patient. The Audit Trail tab provides a log of each action taken on a folder, time and date of action, by whom the action was performed and a message.

Actions: To Financial Auditor, Hold. Note, and Return to Bill Payer Note and Hold Actions

The Note action may be used to mark down special information or questions for the DCS. In some cases, it may be necessary to hold a folder until more information is available. To put a folder in the Hold Queue, a Hold action may be selected by the Pre-Auditor. The system may return Hold items to the Pre-Auditor's To Do list in a pre-set number of days. The Alert Message column will indicate that it is a task returned from the hold queue. To manually retrieve an item from the Hold queue, the Pre-Auditor may select the Watch List selection button to display open tasks. The Pre-Auditor may then open the task the Pre-Auditor would like to return and submit it back to the main queue.

To Financial Auditor Review Action

After validating the provider details, the folder may be forwarded from the Pre-Auditor to a Financial Auditor for review. To do so, a Pre-Auditor may select a To Financial Review action selection presented in the graphical user interface to send the folder to the stage where the payment details get verified.

Financial Auditor Role

A primary function of the Financial Auditor 2010 may be to oversee bill payments and make adjustments, if necessary, for compliance with various guidelines set forth by the particular implementation.

The To Do List of the Financial Auditor may include a bill payment summary form with the following available tabs and actions (with tabs displayed along the top of the form, actions appearing at the bottom of the form):

a) Tabs: Bill Payment View tab, Notes tab, and Audit Trail tab. The views presented after selection of the various tabs displayed to the Financial Auditor may be similar to those displayed to the Bill Payer and/or the Pre-Auditor. Accordingly, the Bill Payment View may provide a summary of the details submitted by a bill payer. The Notes tab offers an open text area for remarks relating to the patient. The Audit Trail tab may provide a log of each action taken on a folder, time and date of action, by whom the action was performed and a message.

b) Actions: To Financial Auditor action selection, Hold action selection, Note action selection, Return to Bill Payer action selection, and an Authorize action selection. The Note and Hold actions available to the Financial Auditor may be similar to that available to the Bill Payer and/or the Pre-Auditor. The Note action may be used by the Financial Auditor to mark down special information or a message for the bill payer. The Hold action, may be used to put the folder in the Hold Queue. The Financial Auditor may manually retrieve an item from the Hold queue via a Watch List selection presented in the graphical user interface.

Return to Bill Payer Action

To submit the folder back to the bill payer to be re-entered, the Financial Auditor may select a Return to Bill Payer action selection presented in the graphical user interface. The system will then present the originating Bill Payer with the task in the Bill Payer's To Do list with an alert message indicating that the folder has been returned by the Financial Auditor and the date returned.

Authorize Action

To approve the processed bill to be paid, the Financial Auditor may select an Authorize action which indicates to the system that payment of the bill has been authorized.

Vendor Administration Utility

The system may include a Vendor Administration Utility (VAU) for managing vendor profiles and allowing users to add, edit and/or delete vendors. The VAU may permit a user to search a vendor database of the system and view vendor profiles stored in the database. The VAU may also permit importing/exporting of some or all of the vendor database to and from a file.

Document Repository

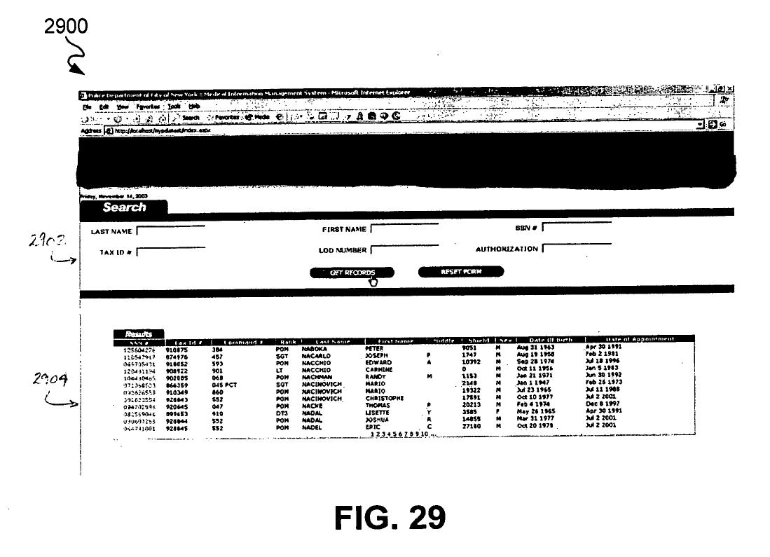

The system may include a document repository. The system may also include a graphical user interface to permit a user to access the document repository. The graphical user interface for the Document Repository may include views for Search, Results, Document Selector, Profile and Image View. FIG. 29 is a schematic diagram of an illustrative graphical user interface 2900 for a Document Repository presenting Search and Results views in accordance with an exemplary embodiment.

Search View 2902

The Search view 2902 may comprise a form to input criteria and search for documents across the available document repositories: medical, billing and clinical records. As shown in FIG. 29, the search form may include the following search criteria: Social Security Number, Tax ID Number, Last Name, First Name, Line of Duty (LOD) Number, and Authorization Number.

Results View 2904

The Results view 2904 may list the record or records that match the search criteria entered. This view displays in a tabular form in the pane below a Search form.

Profile View 3002

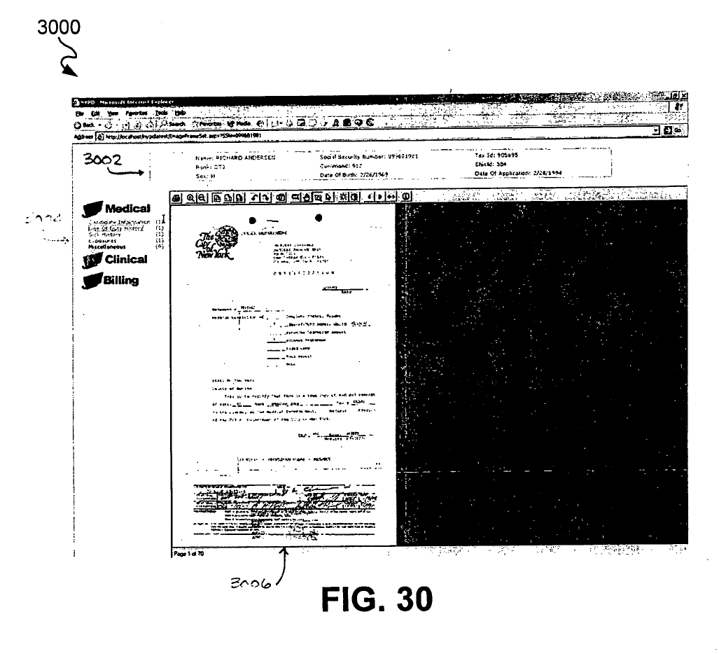

FIG. 30 is a schematic diagram of an illustrative graphical user interface 2900 for a Document Repository presenting Profile, Document Selector, and Image views in accordance with an exemplary embodiment.

The Profile view 3002 may display the selected member's pedigree information. The fields displayed may include: Name, Social Security Number, Tax ID Number, Rank, Command, Shield, Sex, Date of Birth, and Date of Appointment.

Profile view 3002 may be displayed in the top portion of the screen for easy reference while viewing images.

Document Selector View 3004

The Document Selector view 3004 may display the document repositories and documents available to the system user for the selected record. Documents may be organized into one of three repositories: medical, clinical and billing. A user's system role may determine which document repositories the user may be allowed to view. Clicking on a folder may expand its contents. Document types may be displayed to indicate that one or more images are available for viewing. The number of images stored may be displayed next to the document type.

Image View 3006

The Image view pane 3006 may occupy a frame of the graphical user interface. When a document type is selected from the Document Selector pane 3004, the system may launch an image inside the Image view frame.

Performing a Search

The Document Repository may include a search component. The system may include several ways to perform a search:

a) Member Information—Find all records associated with a specific member by the following database fields: Last Name, First Name, Tax ID and/or Social Security Number;

b) Authorization Number—Directly search for records associated with a specific authorization number; and

c) Line of Duty Number—Find records related to a specific line of duty number.

A search may return records matching input criteria for all the relevant document repositories. If the database does not contain records corresponding to the search criteria, the results table may appear empty.

Depending on the database fields searched (member information or authorization/LOD) one of two table layouts may appear in the results view.

The Member search is designed to return all documents related to a specific member. The search results table may display the following data: Social Security Number, Tax ID Number, Command Number, Rank, Last Name, First Name, Middle Initial, Shield Number (i.e., employee number), Sex, Date of Birth, and Date of Appointment.

The Authorization and LOD searches allow a user to look for documents related to bills and line of duty injuries, respectively. The search results table may displays the following data: LOD number, and Authorization or Bill Number.

Exemplary Network

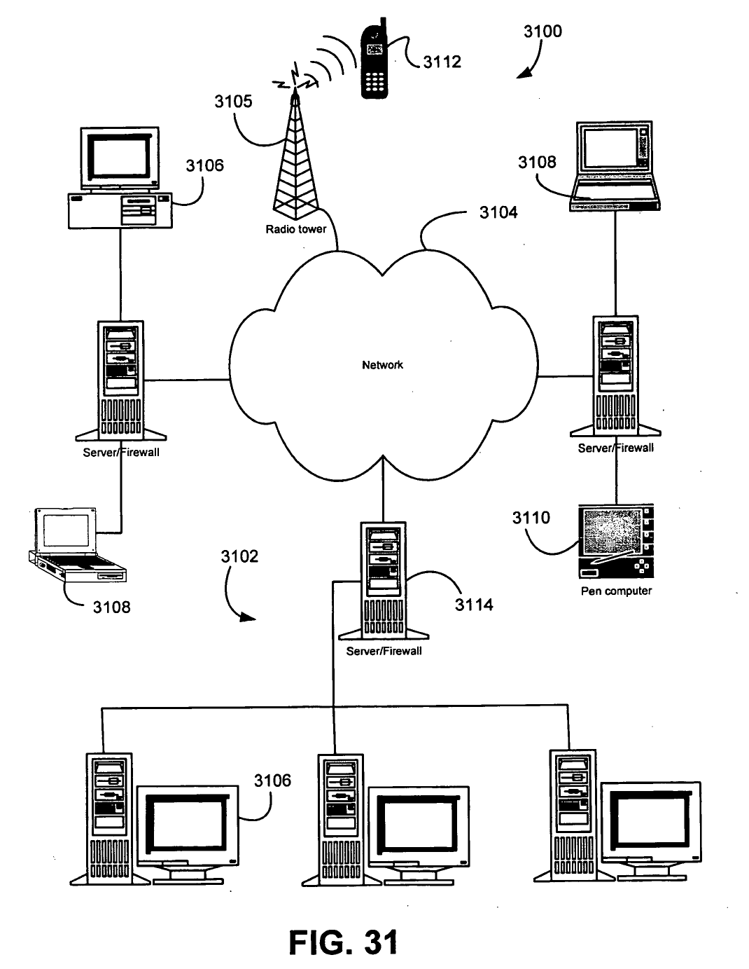

FIG. 31 illustrates an exemplary network system 3100 with a plurality of components 3102 in accordance with one embodiment of the present invention. As shown, such components include a network 3104 which take any form including, but not limited to a local area network, a wide area network such as the Internet, and a wireless network 3105. Coupled to the network 3104 is a plurality of computers which may take the form of desktop computers 3106, lap-top computers 3108, hand-held computers 3110 (including wireless devices 3112 such as wireless PDA's or mobile phones), or any other type of computing hardware/software. As an option, the various computers may be connected to the network 3104 by way of a server 3114 which may be equipped with a firewall for security purposes. It should be noted that any other type of hardware or software may be included in the system and be considered a component thereof.

Representative Hardware Environment

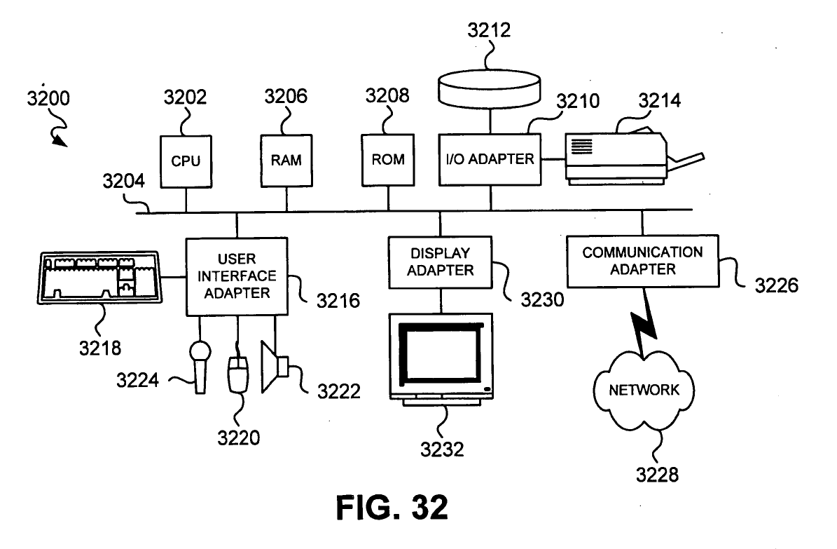

A representative hardware environment associated with the various components of FIG. 31 is depicted in FIG. 32. In the present description, the various sub-components of each of the components may also be considered components of the system. For example, particular software modules executed on any component of the system may also be considered components of the system. In particular, FIG. 32 illustrates an exemplary hardware configuration of a workstation 3200 having a central processing unit 3202, such as a microprocessor, and a number of other units interconnected via a system bus 3204.

The workstation shown in FIG. 32 includes a Random Access Memory (RAM) 3206, Read Only Memory (ROM) 3208, an I/O adapter 3210 for connecting peripheral devices such as, for example, disk storage units 3212 and printers 3214 to the bus 3204, a user interface adapter 3216 for connecting various user interface devices such as, for example, a keyboard 3218, a mouse 3220, a speaker 3222, a microphone 3224, and/or other user interface devices such as a touch screen or a digital camera to the bus 3204, a communication adapter 3226 for connecting the workstation 3200 to a communication network 3228 (e.g., a data processing network) and a display adapter 3230 for connecting the bus 3204 to a display device 3232. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may also be written using Java, C, and the C++ language and utilize object oriented programming (OOP) methodology. OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

Transmission Control Protocol/Internet Protocol (TCP/IP) is a basic communication language or protocol of the Internet and may be used as a communications protocol in the private networks. TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. TCP/IP uses a client/server model of communication in which a computer user (a client) requests and is provided a service (such as sending a Web page) by another computer (a server) in the network.

A virtual private network (VPN) is a private data network that makes use of the public telecommunication infrastructure, maintaining privacy through the use of a tunneling protocol and security procedures. Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing. Wi-Fi (short for “wireless fidelity”) is a high-frequency wireless local area network (WLAN). Wi-Fi is specified in the 802.11b specification from the Institute of Electrical and Electronics Engineers (IEEE) and is part of a series of wireless specifications together with 802.11, 802.11a, and 802.11g. All four standards use the Ethernet protocol and CSMA/CA (carrier sense multiple access with collision avoidance) for path sharing.

Encryption is the conversion of data into a form, called a ciphertext, that cannot be easily understood by unauthorized people. Decryption is the process of converting encrypted data back into its original form, so it can be understood. Rivest-Shamir-Adleman (RSA) is an Internet encryption and authentication system that involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet. The private key is used to decrypt text that has been encrypted with the public key. Thus, if a first party sends a message to a second party, the recipient second party may be able to find out the first party's public key (but not the first party's private key) from a central administrator and encrypt a reply message back to the first party using the first party's own public key. When the first party receives the reply message, the reply message may be decrypted by the first party with the first party's private key. In addition to encrypting messages (which ensures privacy), a first party may be able authenticate themselves to second party so that the second party can confirm the identity of the first party (and thus know that it is really the first party who sent the message) by using a private key to encrypt a digital certificate. When the second party receives the encrypted digital certificate, the second party may use the first party's public key to decrypt it.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface. On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications. Plug-in applications are programs that can easily be installed and used as part of your Web browser. A plug-in application is recognized automatically by the browser and its function is integrated into the main HTML file that is being presented. A browser is an application program that provides a way to look at and interact with all the information on the World Wide Web.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed:

1. A method for processing a claim, comprising:
receiving from an intake site information about a claim brought by a claimant;
creating a record for the claim in a database that includes the information about the claim received from the intake site;
presenting information from the record to a reviewer for determining whether to approve the claim;
receiving information relating to an action taken by the/each reviewer regarding the claim;
updating the record in the database to include the information relating to the action; and
providing at least one of the intake site and the reviewer with status information about a current status of the claim, the status information being updated at least until the claim has been approved by the reviewer.

2. The method of claim 1, wherein the action comprises sending the claim to a hold queue.

3. The method of claim 2, further comprising re-presenting information from record to the review after a predetermined amount of time after performance of the action and requiring the review to perform a subsequent action for determining whether to approve the claim.

4. The method of claim 1, wherein information about previously taken actions relating to the claim is presented to at least one of the intake site and the reviewer.

5. The method of claim 4, wherein the information about previously taken actions is presented as an audit trail in a graphical user interface.

6. The method of claim 1, wherein the information received from the intake site and the reviewer is received via a network.

7. The method of claim 6, wherein the intake site and the reviewer are presented with a graphical user interface for inputting information relating to the claim.

8. The method of claim 1, further comprising generating an approval form after receipt of the approval from the reviewer.

9. The method of claim 1, further comprising: providing a service provider access to information from the record associated with the claim for obtaining of an assessment of the claim from the service provider to identify a service for resolving the claim; receiving information relating to the assessment from the service provider; and updating the record in the database to include the information relating to the assessment.

10. The method of claim 9, further comprising presenting information from the record to the reviewer for determining whether to authorize the one or more services identified in the assessment within a predefined amount of time.

11. The method of claim 10, further comprising receiving an authorization from the reviewer for performing the one or more services; and sending a notification to the service provider indicating approval by the reviewer for performing the one or more services.

12. The method of claim 11, further comprising receiving information indicating the performance of at least one of the approved services from the service provider after the service provider has performed the at least one of the approved services; and updating the record in the database to include the information indicating the performance of the at least one of the approved services.

13. The method of claim 12, further comprising transmitting a notification to at least one of intake site, the reviewer and the service provider that indicates the performance of the at least one of the approved services.

14. The method of claim 1, wherein the action taken by the reviewer comprises recommending that a second reviewer review at least a portion of the information of the record.

15. The method of claim 1, further comprising presenting to a bill payer a graphical representation of a bill received for a service performed on the claimant; receiving from the bill payer input for generating a payment for the bill, the input being obtained from the graphical representation of the bill and the information from the record; and updating the record to include the input for generating the payment for the bill.

16. The method of claim 15, further comprising presenting information from the record to the reviewer for determining whether to authorize the payment of the bill; wherein the action performed by the reviewer relates to the payment of the bill.

17. The method of claim 16, further comprising receiving an authorization for payment of the bill from the reviewer; and providing at least one of the intake site, the service provider, the bill payer and the reviewer with a notification indicating that the authorization for payment of the bill.

18. The method of claim 15, wherein the graphical representation of the bill comprises a captured digital image.

19. A computer program product for processing a claim, comprising:
computer code for receiving from an intake site information about a claim brought by a claimant;
computer code for creating a record for the claim in a database that includes the information about the claim received from the intake site;
computer code for presenting information from the record to a reviewer for determining whether to approve the claim;
computer code for receiving information relating to an action taken by the reviewer regarding the claim;
computer code for updating the record in the database to include the information relating to the action; and
computer code for providing at least one of the intake site and the reviewer with status information about a current status of the claim, the status information being updated at least until the claim has been approved by the reviewer.

20. A system for processing a claim, comprising:
a network;
an intake site, a plurality of reviewers, a service provider and a bill payer coupled to the network;
a claim process engine coupled to the network and having:
logic for receiving from the intake site information about a claim brought by a claimant;
logic for creating a record for the claim in a database;
logic presenting information from the record to at least one of the reviewers for determining whether to approve the claim;
logic for presenting information to the service provider for presenting information about claim for assisting the service provider in assessing the claim and recommending one or more services for resolving the claim;
logic for presenting bill payment information to the bill payer;
logic for receiving information relating to actions taken by intake site, the reviewers, the service provider and the bill payer regarding the claim;
logic for affording a hold queue wherein actions sending the claim to the hold queue requires a subsequent action to be taken after a predetermined amount of time;
logic for updating the record in the database to include the information relating to the action; and
logic for providing at least one of the intake site, one or more of the reviewers and the bill payer with status information about a current status of the claim.
